(19) United States
(12) Patent Application Publication
(10) Pub. No.: US 2009/0239170 A1
(43) Pub. Date: Sep. 24, 2009

(54) METHOD FOR PRODUCING TONER, AND TONER

(76) Inventors: Takahiro Honda, Fujinomiya-shi (JP); Yohichiroh Watanabe, Fuji-shi (JP); Kazumi Suzuki, Sunto-gun (JP); Shinji Ohtani, Sunto-gun (JP); Yoshihiro Norikane, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/405,741

(22) Filed: Mar. 17, 2009

(30) Foreign Application Priority Data
Mar. 17, 2008 (JP) 2008-067628
Nov. 17, 2008 (JP) 2008-293160

(51) Int. Cl. G03G 9/087; G03G 9/08

(52) U.S. Cl. 430/108.8; 430/137.1

(57) ABSTRACT

A method for producing a toner, the method including discharging a toner composition liquid from a plurality of nozzles to form liquid droplets thereof, the toner composition liquid being prepared by dissolving or dispersing in a solvent a toner composition containing at least a binder resin, a colorant, an acid-modified hydrocarbon wax and an unmodified hydrocarbon wax, the waxes serving as a releasing agent, and solidifying the liquid droplets so as to form solid particles.

### BACKGROUND OF THE INVENTION

1. Field of the Invention

The present invention relates to a method for producing a toner used in a developer for developing a latent electrostatic image in, for example, electrophotography, electrostatic recording and electrostatic printing, and to a toner produced with the production method.

2. Description of the Related Art

Developers used in, for example, electrophotography, electrostatic recording and electrostatic printing adhere, in a developing step, to an image bearing member (e.g., a latent electrostatic image bearing member) on which a latent electrostatic image has been formed; then, in a transfer step, are transferred from the image bearing member onto a recording medium (e.g., recording paper sheet); and then, in a fixing step, are fixed on the surface of the recording medium. As have been known, such developers that develop a latent electrostatic image formed on the image bearing member are roughly divided into two-component developers formed of a carrier and a toner and one-component developers requiring no carrier (magnetic or non-magnetic toners).

Conventionally, as a dry-process toner used in, for example, electrophotography, electrostatic recording and electrostatic printing, a so-called “pulverized toner” is widely used, which is produced by melt-kneading a toner binder (e.g. a styrene resin and a polyester resin) together with a colorant, followed by finely pulverizing.

Also, the recent interest has focused on so-called polymerization toners produced with toner production methods based on the suspension polymerization method and/or the emulsion polymerization aggregation method. In addition, Japanese Patent Application Laid-Open (JP-A) No. 07-152202 discloses a polymer dissolution suspension method. In this method, toner materials are dispersed and/or dissolved in a volatile solvent such as an organic solvent having a low boiling point; and the resultant liquid is emulsified in an aqueous medium in the presence of a dispersant to form liquid droplets; and the volatile solvent is removed from the liquid droplets while shrinking the volume thereof.

Unlike the suspension polymerization method and the emulsion polymerization aggregation method, the polymer dissolution suspension method is advantageous in that a wider variety of resins, in particular, a polyester resin can be used which is used for forming a full-color image having transparency and smoothness in image portions after fixing.

The polymerization toners must be prepared in an aqueous medium in the presence of a dispersant and thus, the dispersant remains on the surface of the formed toner particles and degrades chargeability and environmental stability thereof. In order to avoid such an unfavorable phenomenon, the remaining dispersant must be removed using a very large amount of wash water and thus, the production method for the polymerization toner is not necessarily satisfactory.

As a toner production method replacing the above, JP-A No. 2003-262976 discloses a method in which a toner composition liquid is formed into microdroplets by piezoelectric pulsation, and the thus-formed microdroplets are solidified through drying to produce toner particles. Also, JP-A No. 2003-280236 discloses a method in which a toner composition liquid is formed into microdroplets by the action of thermal expansion, and the thus-formed microdroplets are solidified through drying to produce toner particles. In addition, JP-A No. 2003-262977 discloses a method in which a toner composition liquid is formed into microdroplets using an acoustic lens, and the thus-formed microdroplets are solidified through drying to produce toner particles. However, these methods pose a problem in that the number of liquid droplets that can be ejected from one nozzle per unit of time is limited to make their productivity low. Furthermore, it is difficult to prevent the particle size distribution of the formed toner from broadening due to aggregation of liquid droplets. Thus, these methods are far from satisfaction in terms of monodispersibility of the formed toner as well as productivity.

Also, JP-A Nos. 2006-28432 and 2006-28433 disclose a method in which toner materials containing a thermosetting resin or UV curable resin is finely dispersed in a dispersion medium; the resultant dispersion is intermittently discharged from nozzles in the form of liquid droplet; the formed liquid droplets are aggregated and then a thermosetting resin or UV curable resin is cured for stabilizing particle formation. This method, however, exhibits low productivity and forms toner particles having insufficient monodispersibity, similar to the above-described methods disclosed in JP-A Nos. 07-152202, 2003-262976, 2003-280236 and 2003-262977. The toner produced with this method does not have a sufficient fixing property, although the resin is cured after particle formation.

The above granulation method disclosed in JP-A Nos. 2006-28432 or 2006-28433 is characterized in that an excitation part (vibration part) is in direct contact with a fluid. In this configuration, when the number of the excitation part is identical to that of micropores (orifices) (i.e., excitation parts correspond one-to-one to micropores (orifices)), the formed toner have a sharp particle size distribution. Meanwhile, when a plurality of micropores and one excitation part are used, the size of liquid droplets discharged from micropores varies with the distance between the excitation part and each micropore and thus, toner particles formed from liquid droplets discharged from different micropores (orifices) have different particle diameters.

Meanwhile, a dry-process toner image transferred onto paper etc. after development is generally molten for fixing by bringing, for example, a heat roller or belt into contact therewith, since good thermal efficiency can be attained. When the dry-process toner image is fixed with a heat roller or belt having too high temperature, excessively molten toner undesirably adheres to the heat roller or belt; i.e., hot offset occurs. In contrast, when fixed with a heat roller or belt having too low temperature, the dry-process toner image is not sufficiently molten, leading to problematic insufficient fixing. Thus, demand has arisen for toners having good hot offset resistance (i.e., a temperature at which hot offset occurs is high) and good low-temperature fixing property (i.e., a temperature required for fixing a formed toner image is low), from the viewpoints of energy saving and downsizing of relevant apparatuses (e.g., copiers). Also, toners are required to have a heat resistance/storage stability so as to be free from blocking during storage and at an internal temperature of apparatuses. In particular, toners used in full color copiers or printers must have low melt viscosity, since a color image is required to have high glossiness and desired color mixing property. Thus, a polyester toner binder sharply melting is used for toner production.

However, toners produced using such a polyester toner binder easily cause hot offset and thus, silicone oil, etc. are applied onto a heat roller provided in conventional apparatuses for forming a full color image. In this case, an oil tank and oil-applying device must be provided to apply silicone oil to a heat roller, making apparatuses larger and more complicated. Furthermore, it is indispensable that oil adheres to, for example, a copying paper and a film for use in overhead projectors (OHPs) and thus, the adhering oil degrades printing property of an aqueous ink on the copying paper, and color tone of a printed image on the OHP film.

In view of this, in order to prevent molten toner from adhering to a heat roller without oil application, a releasing agent (e.g., wax) is generally incorporated into a toner. The releasing effect of the toner brought by wax depends greatly on its dispersion state in a binder. When dissolved in the binder, wax does not exhibit its releasing property. Wax existing as domain particles with being undissolved in the binder resin can improve the formed toner in releaseability. When dispersed domain particles have too large particle diameter, a relatively large amount of wax is present in the vicinity of the surface of toner particles, degrading flowability of the particles due to aggregation effect given by the wax. Also, after long-term use, the wax is transferred onto a carrier and/or photoconductor to cause filming or to prevent formation of a high-quality image. In the case of color toners, color reproducibility and transparency are problematically impaired. In contrast, when dispersed domain particles have too small particle diameter, wax particles are excessively finely dispersed to exhibit insufficient releasing effect. Thus, the particle diameter of dispersed wax particles must be controlled, but cannot yet be suitably controlled. Particularly in a toner produced with the pulverization method, the particle diameter of dispersed wax particles depends greatly on shearing force applied during melt-kneading. However, polyester resins, which are often used as toner binders in recent years, have low viscosity and cannot receive sufficient shearing force for kneading. Thus, difficulty is encountered in forming dispersed wax particles having an appropriate particle diameter by controlling dispersion of wax.

Also, when the pulverization method is used, many wax particles are exposed to the surface of the formed toner as a fracture surface.

Waxes are softer and higher in adhesive property than resins and thus, many wax particles existing on the toner surface easily cause so-called filming in which a film made of wax is formed on the photoconductor.

For producing a high-quality image, toners have been improved by, for example, making the toner particle diameter smaller or the particle size distribution narrower. The toner particles produced with the common kneading pulverizing method have an amorphous shape and thus, are further pulverized through stirring together with carrier particles in the development area of an image forming apparatus. In addition, when used as a one-component developer, the above toner particles are further pulverized through contact with, for example, a developing roller, a toner-feeding roller, a layer thickness-controlling blade and a frictionally charging blade. As a result, extremely fine particles are formed and a flowability improver is embedded in the toner surface, resulting in degrading image quality. Also, the toner particles having such a shape exhibit poor powder flowability and thus, require a large amount of a flowability improver. Furthermore, the filling rate of a toner bottle with such toner particles becomes low, preventing downsizing of apparatuses.

Also, transfer processes for forming a full-color image become more complicated, which transfer multi-color toner images from photoconductors onto a recording medium or paper. When the pulverized toner having an amorphous shape is used in the transfer processes, print through is often observed on the formed image due to its poor transferability and a large amount of toner must be consumed for compensating the print through, which is problematic.

Under such circumstances, there are increasing needs to more reliably transfer toner particles, to reduce the amount of toner consumed, to form high-quality image involving no image through, and to reduce running cost. When transfer efficiency is very high, there is not required to be provided a cleaning unit for removing toner particles remaining the photoconductor or transfer medium. Other advantageous effects are as follows: apparatuses can be downsized, cost reduction can be attained, and no toner to be disposed of is generated. In order to overcome the above-described problems caused by toner particles having an amorphous shape, attempts have been made to develop various production methods for spherical toner particles.

Hitherto, various attempts have been made to improve properties of toners. In order to improve toners in low-temperature fixing property and offset resistance, a low-softening-point releasing agent (wax) such as polyolefin is incorporated thereinto. JP-A Nos. 06-295093, 07-84401 and 09-258471 disclose toners containing a wax having a specific DSC endothermic peak. These toners, however, must be further improved in low-temperature fixing property, offset resistance and developability.

JP-A Nos. 05-341577, 06-123999, 06-230600, 06-295093 and 06-324514 disclose toners containing, as a releasing agent, candellila wax, higher fatty acid wax, higher alcohol wax, vegetable natural wax (e.g., carnauba wax and rice wax), montan ester wax, etc. These toners, however, must be further improved in low-temperature fixing property, offset resistance, developability (chargeability) and durability. In general, when such a low-softening-point releasing agent is incorporated, the formed toner has decreased flowability and degraded developability and transferability. In addition, its chargeability, durability and storage stability are easily adversely affected.

In order for toners to have a wider temperature range at which offset does not occur during fixing, JP-A Nos. 11-258934, 11-258935, 04-299357, 04-337737, 06-208244 and 07-281478 disclose toners containing two or more releasing agents. These toners, however, pose a problem in that the releasing agents are not uniformly dispersed in toner particles.

JP-A No. 08-166686 discloses a toner containing a polyester resin and two different offset-preventing agents having an acid value and different softening points. This toner, however, involves insufficient developability. Also, JP-A Nos. 08-328293 and 10-161335 disclose toners containing dispersed wax particles having a specific particle diameter. These toners, however, do not exhibit sufficient releaseability after fixing, since the wax particles do not exist in a defined state and at a defined position.

Furthermore, JP-A No. 2001-305782 discloses a toner whose surface has immobilized spherical wax particles. This toner, however, is degraded in developability and transferability since the wax particles present on the toner surface decrease the toner in flowability. In addition, its chargeability, durability and storage stability are easily adversely affected. JP-A No. 2001-26541 discloses toner particles encapsulating wax particles with being localized in the vicinity of their surfaces. The toner particles are not satisfactory from the viewpoints of offset resistance, storage stability and durability.

Japanese Patent Application Publication (JP-B) Nos. 52-3304 and 07-82255 describe that a polyolefin releasing agent (e.g., low-molecular-weight polyethylenes and low-molecular-weight polypropylenes) or a resin produced through graft polymerization between the polyolefin resins and styrene resins is advantageously incorporated into a pulverized toner produced by using a styrene resin as a toner binder. The styrene resin, however, degrades low-temperature fixing property of the formed toner and thus, is not suitably used for producing toners having such low-temperature fixing property that meets the recent requirement for energy saving.

In view of this, JP-A Nos. 2000-75549 and 2001-249485 disclose toner particles containing, in combination, a polyolefin resin and a polyester resin excellent in low-temperature fixing property. However, these toner particles, which are produced with the kneading pulverizing method in which a toner composition is melt-kneaded, finely pulverized and classified, have variation in their shape and surface structure. These shape and surface structure slightly vary depending on pulverization property of materials used and on the conditions for a pulverization step, and cannot be easily controlled as desired. Also, a toner having a narrower particle size distribution is difficult to produce in consideration of cost elevation and the limit of classification ability. In the case of pulverized toners, it is very important that their average particle diameter calculated from the particle size distribution thereof is small, in particular, 6 μm or smaller in consideration of production yield, productivity and cost.

Meanwhile, spherical toner particles having a smaller particle diameter can be easily produced with a method in which a toner composition is discharged from nozzles having small pore size, but a new problem—nozzle clogging—arises in this method. Particularly when a toner containing a releasing agent (wax) is produced, coarse or aggregated wax particles in a toner composition easily cause nozzle clogging and thus, it is essential that the particle diameter of dispersed wax particles is desirably controlled. Needless to say, it is also important that the state of the wax particles in the toner is desirably controlled.

### BRIEF SUMMARY OF THE INVENTION

In view of the foregoing, the present invention has been made to solve the above-described existing problems and aims to achieve the following objects. Specifically, an object of the present invention is to provide a production method for a toner, which method can efficiently produce a toner having a small particle diameter without nozzle clogging due to wax particles; and a toner produced with the production method. This toner causes no filming on a photoconductor, etc.; is excellent in offset resistance and low-temperature fixing property; has a monodisperse particle size distribution which has not attained with a conventional method; has no or almost no variation in many characteristic values (e.g., flowability and chargeability) between toner particles, differing from toners produced with conventional production methods; can form a high-resolution, high-definition, high-quality image involving no degradation in image quality for a long period of time.

The method for producing a toner and the toner of the present invention are as follows.

(1) A method for producing a toner, the method including:

discharging a toner composition liquid from a plurality of nozzles to form liquid droplets thereof, the toner composition liquid being prepared by dissolving or dispersing in a solvent a toner composition containing at least a binder resin, a colorant, an acid-modified hydrocarbon wax and an unmodified hydrocarbon wax, the waxes serving as a releasing agent, and

solidifying the liquid droplets so as to form solid particles.

(2) The method according to (1) above, wherein the discharging is periodically discharging the toner composition liquid from the nozzles, while a thin film having the nozzles is vibrated.

(3) The method according to (2) above, wherein the thin film is disposed in a reservoir for the toner composition liquid, and the periodically discharging is discharging the toner composition liquid from the nozzles by vibrating the thin film using a mechanically vibrating unit.

(4) The method according to (3) above, wherein the mechanically vibrating unit is a ring-shaped vibration generating unit disposed on the thin film so as to surround an area where the nozzles are arranged.

(5) The method according to (3) above, wherein the mechanically vibrating unit is a vibrating unit having a vibrating surface disposed in parallel with the thin film, and the vibrating surface vertically vibrates in a perpendicular direction to the thin film.

(6) The method according to (5) above, wherein the mechanically vibrating unit is a horn vibrator.

(7) The method according to any one of (3) to (6) above, wherein the mechanically vibrating unit vibrates at a vibration frequency of 20 kHz or higher and lower than 2.0 MHz.

(8) The method according to (1) above, wherein the discharging is performed using a nozzle plate having nozzles which is disposed in a reservoir for the toner composition liquid and one vibration generating unit having a vibrating surface disposed in parallel with the nozzle plate so as to utilize resonance phenomenon of the toner composition liquid present in the reservoir.

(9) The method according to (8) above, wherein the resonant frequency of the liquid present in the reservoir is lower than the resonant frequency of a structure having a member constituting the reservoir and the nozzle plate.

(10) The method according to any one of (1) to (9) above, wherein the nozzles each have a pore size of 1 μm to 40 μm.

(11) The method according to any one of (1) to (10) above, wherein the solvent is an organic solvent, and the solidifying is removing the organic solvent from the liquid droplets.

(12) The method according to any one of (1) to (11) above, wherein a ratio A/B satisfies the relation 0.1≦A/B≦4.0, where A denotes an amount of the acid-modified hydrocarbon wax added to the toner composition and B denotes an amount of the unmodified hydrocarbon wax added to the toner composition.

(13) The method according to any one of (1) to (12) above, wherein a sum A+B is 0.1 parts by mass to 20 parts by mass per 100 parts by mass of the binder resin, where A denotes an amount of the acid-modified hydrocarbon wax added to the toner composition and B denotes an amount of the unmodified hydrocarbon wax added to the toner composition.

(14) The method according to any one of (1) to (13) above, wherein the acid-modified hydrocarbon wax has an acid value of 1 mgKOH/g to 90 mgKOH/g.

(15) The method according to any one of (1) to (14) above, wherein the acid-modified hydrocarbon wax and the unmodified hydrocarbon wax each have a melt viscosity of 1 mPa·s to 30 mPa·s at 120° C.

(16) The method according to any one of (1) to (15) above, wherein the acid-modified hydrocarbon wax is produced by modifying a paraffin wax with maleic anhydride.

(17) The method according to any one of (1) to (16) above, wherein the unmodified hydrocarbon wax is a paraffin wax.

(18) A toner obtained by the method according to any one of (1) to (17) above, wherein the toner has a particle size distribution (mass average particle diameter/number average particle diameter) of 1.00 to 1.15.

(19) The toner according to (18) above, having a mass average particle diameter of 1 μm to 20 μm.

The method for producing a toner (toner production method) of the present invention uses a toner composition liquid containing, as a releasing agent, at least a hydrocarbon wax modified with an acid (an acid-modified hydrocarbon wax) and an unmodified hydrocarbon wax, with the waxes being finely dispersed so as to prevent crystal growth. Thus, in this production method, even when liquid droplets of the toner composition liquid are periodically formed and discharged from nozzles with a mechanically vibrating unit, toner particles having a monodisperse particle size distribution which has not been conventionally attained can be efficiently produced without nozzle clogging.

The toner produced using the toner production method of the present invention is very advantageous in that it does not involve no or almost negligible variation in its particle size distribution unlike the case where conventional production methods for pulverized toners and chemical toners are used. Thus, the toner can consistently form a desired image even after repetitive development.

Also, by using both the acid-modified hydrocarbon wax and the unmodified hydrocarbon wax, the toner produced with the toner production method of the present invention incorporates these releasing agents in a stable state and exhibits excellent hot offset resistance. Furthermore, in each toner particle, finely dispersed acid-modified hydrocarbon wax particles are present in the vicinity of the surface and dispersed unmodified hydrocarbon wax particles with a larger particle diameter are present in the vicinity of the center (note that the reason for this is unclear) and thus, the toner exhibits more excellent hot offset resistance. In addition, the toner produced with a method in which a toner composition liquid is periodically formed and discharged from nozzles, the finely dispersed releasing agent is not completely exposed to the toner surface, avoiding filming on a photoconductor, etc. caused by the releasing agent. Also, the formed toner has a small particle diameter and a very narrow particle size distribution and thus, can consistently form a high-quality image.

Further, these effects can be assuredly attained by adjusting the vibration frequency of the vibrating unit to 20 kHz or higher and lower than 2.0 MHz; by adjusting the ratio A/B of the amount A of the acid-modified hydrocarbon wax added to the toner composition to the amount B of the unmodified hydrocarbon wax added to the toner composition to 0.1 to 4.0; by adjusting the sum of the waxes added to 0.1 parts by mass to 20 parts by mass per 100 parts by mass of the binder resin; by adjusting the melt viscosity of each of the acid-modified hydrocarbon wax and the unmodified hydrocarbon wax to 1 mPa·s to 30 mPa·s as measured at 120° C.; by adjusting the acid value of the acid-modified hydrocarbon wax to 1 mgKOH/g to 90 mgKOH/g; and by using, as the acid-modified hydrocarbon wax, a paraffin wax (unmodified hydrocarbon wax) modified with maleic anhydride.

### BRIEF DESCRIPTION OF THE DRAWINGS

FIG. 1 schematically illustrates the configuration of a toner production apparatus used in the present invention, which employs a mechanically vertically vibrating unit.

FIG. 2 is a schematic cross-sectional view of a liquid droplet jetting unit illustrated in FIG. 1.

FIG. 3 is an explanatory bottom view of an essential part of the liquid droplet jetting unit shown in FIG. 2.

FIG. 4 is an explanatory view of a step-shaped horn vibrator.

FIG. 5 is an explanatory view of an exponential-shaped horn vibrator.

FIG. 6 is an explanatory view of a conical horn vibrator.

FIG. 7 is an explanatory schematic cross-sectional view of another liquid droplet jetting unit.

FIG. 8 is an explanatory schematic cross-sectional view of still another liquid droplet jetting unit.

FIG. 9 is an explanatory schematic cross-sectional view of yet another liquid droplet jetting unit.

FIG. 10 is an explanatory view of a plurality of liquid droplet jetting units shown in FIG. 9 arranged in a row.

FIG. 11 schematically illustrates the configuration of a toner production apparatus used in the present invention, which employs a ring-shaped mechanically vibrating unit.

FIG. 12 is a schematic cross-sectional view of a liquid droplet jetting unit illustrated in FIG. 11.

FIG. 13 is an explanatory bottom view of an essential part of the liquid droplet jetting unit shown in FIG. 12.

FIG. 14 is an explanatory schematic cross-sectional view of a liquid droplet jetting unit used in the present invention.

FIG. 15 is an explanatory schematic cross-sectional view of a comparative liquid droplet jetting unit.

FIG. 16 is an explanatory view of a plurality of liquid droplet jetting units shown in FIG. 12 arranged in a row.

FIG. 17A is an explanatory view of a thin film vibrated.

FIG. 17B is another explanatory view of a thin film vibrated.

FIG. 18 is a graph showing the relation between an area where nozzles are arranged and a displacement ΔL of a thin film which is vibrated in a basic vibration mode by a mechanically vibrating unit.

FIG. 19 is a graph showing the relation between an area where nozzles are arranged and a displacement ΔL of a thin film which is vibrated in a multi-node mode by a mechanically vibrating unit.

FIG. 20 is a graph showing the relation between an area where nozzles are arranged and a displacement ΔL of a thin film which is vibrated in a multi-node mode by a mechanically vibrating unit.

FIG. 21 is an explanatory schematic cross-sectional view of a thin film having a convex portion at its center portion.

FIG. 22A is an assembly view for a liquid droplet jetting unit employing a liquid vibrating mode in the present invention.

FIG. 22B is a schematic cross-sectional view of a liquid droplet jetting unit employing a liquid vibrating mode in the present invention.

FIG. 23A is an explanatory view of the liquid droplet jetting unit shown in FIG. 22B.

FIG. 23B is an explanatory view of the liquid droplet jetting unit shown in FIG. 22B.

### DETAILED DESCRIPTION OF THE INVENTION

### Toner Production Apparatus

As described above, as a means for forming liquid droplets of the toner composition liquid in a vapor phase, the following are known: a single-fluid spray nozzle (pressurization nozzle) designed to pressurize a liquid so as to be sprayed from a nozzle; a multiple-fluid spray nozzle designed to spray a fluid in a state where a liquid and a pressurized gas are mixed; and a rotation disc type sprayer designed to form liquid droplets by the action of centrifugal force brought by a rotating disc. In order to form a toner having a small particle diameter, a multiple-fluid spray nozzle and a rotation disc type sprayer are preferably used. For the multiple-fluid spray nozzle, external mix two-fluid spray nozzles are generally used. However, in order to form particles having a smaller particle diameter and a more uniform particle size distribution, various improvements have been made on multiple-fluid spray nozzles, as exemplified by internal mix two-fluid spray nozzles and four-fluid spray nozzles. To attain similar effects to the above, various improvements have been also made on rotation disc type sprayers, as exemplified by those formed into dish-shaped, bowl-shaped, multi-blade shape, etc.

However, a toner produced with any of these production methods has a relatively broad particle size distribution, and classification is required in some cases.

In order to solve the above-described problems, the present inventors eliminate a need to classify toner particles produced with, for example, a method employing two-fluid spray nozzles, by using a specific toner composition liquid containing finely dispersed, non-aggregated modified wax particles.

Also, the present inventors have conceived a method in which liquid droplets of the toner composition liquid are periodically formed and discharged from a plurality of uniform nozzles of the thin film using a mechanically vibrating unit to produce a toner having a uniform particle size distribution.

That is, an apparatus used in the toner production method of the present invention (hereinafter the apparatus may be referred to as a “toner production apparatus”) can form liquid droplets having a uniform particle diameter through discharging of a toner composition liquid (i.e., a solution or dispersion of a toner composition containing at least a binder resin, a colorant and a specific releasing agent) from a plurality of nozzles of a thin film in the form of liquid droplet, by vibrating the thin film using a liquid droplet forming unit employing a mechanically vibrating unit or by utilizing resonance phenomenon of the toner composition liquid present in a reservoir therefor.

The mechanically vibrating unit configured to vibrate the thin film itself (hereinafter referred to simply as a “film vibrating mode”) may be set in any position, so long as it can vibrate in a perpendicular direction to the thin film having a plurality of nozzles. There are the following two preferred modes in the present invention.

In one mode, there is used a mechanical unit (a mechanically vertically vibrating unit) having a vibrating surface disposed in parallel with a thin film having a plurality of nozzles and configured to vibrate in a perpendicular direction to the thin film (hereinafter this mode may be referred to as a “mode employing a horn vibrator”). In the other mode, there is used a circular mechanically vibrating unit (a ring-shaped mechanically vibrating unit) disposed on the thin film so as to surround an area where a plurality of nozzles are arranged (hereinafter this mode may be referred to as a “mode employing a ring-shaped vibrator).

A mechanically vibrating unit for causing resonance phenomenon of a toner composition liquid present in a reservoir therefor is the same as the above-described mechanical unit (a mechanically vertically vibrating unit) having a vibrating surface disposed in parallel with a thin film having a plurality of nozzles and configured to vibrate in a perpendicular direction to the thin film (hereinafter a mode in which resonance phenomenon of a toner composition liquid present in a reservoir therefor is caused is referred to simply as a “liquid vibrating mode”).

Each of the above mechanically vibrating units will next be described.

### (Film Vibrating Mode Employing Mechanically Vertically Vibrating Unit)

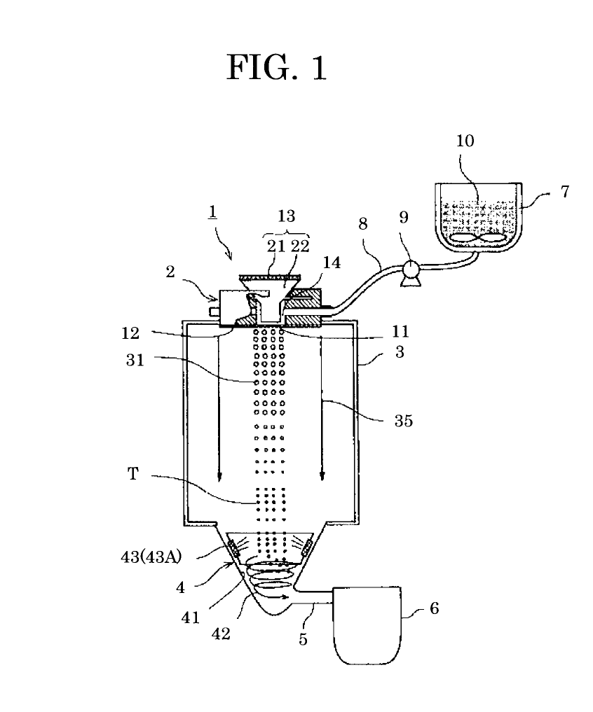

With reference to a schematic configuration of FIG. 1, first will be described a toner production apparatus based on the film vibrating mode employing the mechanically vertically vibrating unit.

A toner production apparatus 1 includes a liquid droplet jetting unit 2 serving as a liquid droplet forming unit, a particle forming section 3 serving as a particle forming unit, a toner collecting section 4, a tube 5, a toner reservoir 6 serving as a toner reserving unit, a material accommodating unit 7 for accommodating a toner composition liquid 10, a liquid feeding pipe 8, and a pump 9. In this apparatus, the liquid droplet jetting unit 2 is used in a periodically liquid forming step of discharging liquid droplets of a toner composition liquid in the present invention; the particle forming section 3 is disposed below the liquid droplet jetting unit 2 and is used in a particle forming step of forming toner particles T by solidifying liquid droplets of the toner composition liquid which are discharged from the liquid droplet jetting unit 2; the toner collecting section 4 collects the toner particles T formed in the particle forming section 3; the toner reservoir 6 reserves the toner particles T transferred via the tube 5 from the toner collecting section 4; the material accommodating unit 7 contains the toner composition liquid 10; the liquid feeding pipe 8 feeds the toner composition liquid 10 from the material accommodating unit 7 to the liquid droplet jetting unit 2; and the pump 9 pressure-feeds the toner composition liquid 10 upon operation of the toner production apparatus 1.

During operation of the toner production apparatus, the toner composition liquid 10 sent from the material accommodating unit 7 can be self-supplied to the liquid droplet jetting unit 2 by virtue of the liquid droplet forming phenomenon brought by the liquid droplet jetting unit 2 and thus, the pump 9 is subsidiarily used for liquid supply. Notably, the toner composition liquid 10 used in this apparatus is a solution/dispersion prepared by dissolving/dispersing, in a solvent, a toner composition containing at least a binder resin, a colorant, an acid-modified hydrocarbon wax, and an unmodified hydrocarbon wax, the waxes serving as a releasing agent.

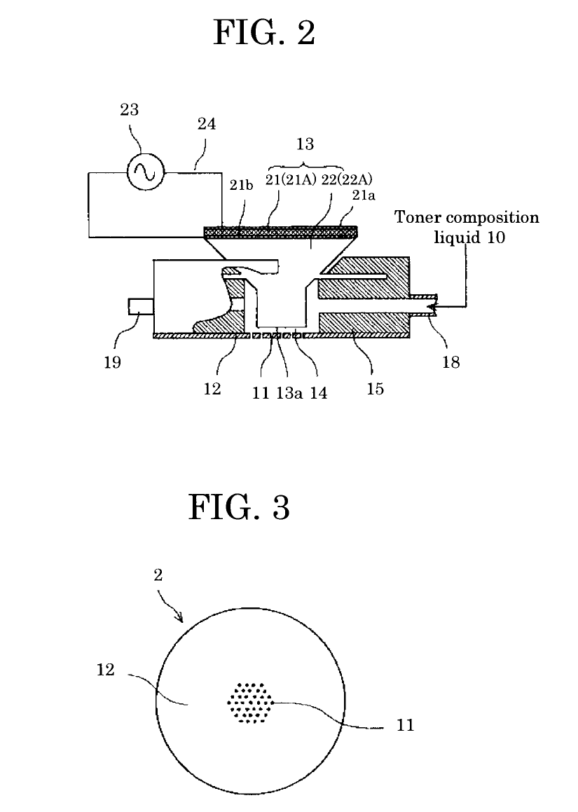

Next will be described the liquid droplet jetting unit 2 with reference to FIGS. 2 and 3. FIG. 2 is a schematic explanatory cross-sectional view of the liquid droplet jetting unit 2; and FIG. 3 is a bottom view of an essential part of the liquid droplet jetting unit 2 shown in FIG. 2, as viewed from the underside.

This liquid droplet jetting unit 2 includes a thin film 12 having a plurality of nozzles (ejection holes) 11, a mechanically vibrating unit (hereinafter referred to as a “vibrating unit”) 13 for vibrating the thin film 12, and a flow passage member 15 forming a reservoir (flow passage) 14 from which the toner composition liquid 10 used in the present invention is fed to a space between the thin film 12 and the vibrating unit 13.

The thin film 12 having a plurality of nozzles 11 is placed in parallel with a vibrating surface 13a of the vibrating unit 13, and part of the thin film 12 is joined or fixed on the flow passage member 15 with solder or a binder resin insoluble in the toner composition liquid 10. In this state, the thin film 12 is positioned substantially perpendicular to a direction in which the vibrating unit 13 is vibrated. A communication unit 24 is provided such that a voltage signal is applied to the top and under surfaces of a vibration generating unit 21 in the vibrating unit 13, and can covert signals received from a drive signal generation source 23 into a mechanical vibration. As the communication unit 24 for giving electric signals, a lead wire whose surface has subjected to insulating coating is suitable. For the vibrating unit 13, it is advantageous, in order to efficiently and stably producing a toner, to use a device exhibiting a large vibration amplitude such as various types of horn-type vibrator and bolting Langevin transducer.

The vibrating unit 13 is composed of the vibration generating unit 21 configured to generate a vibration, and a vibration amplifying unit 22 configured to amplify the vibration generated by the vibration generating unit 21. In this vibrating unit 13, when a drive voltage having a required frequency (drive signal) is applied to between electrodes 21a and 21b of the vibration generating unit 21 from the drive signal generation source (drive circuit) 23, a vibration is excited in the vibration generating unit 21 and then the vibration is amplified by the vibration amplifying unit 22. In this state, the vibrating surface 13a placed in parallel with the thin film 12 is periodically vibrated, and the thin film 12 is vibrated at a required frequency by periodically applied pressure brought by the vibration of the vibrating surface 13a.

The vibrating unit 13 is not particularly limited, so long as it can assuredly vertically vibrate the thin film 12 at a constant frequency, and can be appropriately selected depending on the purpose. As the vibration generating unit 21, there is a need to vibrate the thin film 12, and therefore a bimorph-type piezoelectric element 21A is preferable. The bimorph-type piezoelectric element 21A can excite flexural oscillation and convert electric energy into mechanical energy. Specifically, it can excite flexural oscillation through application of a voltage to vibrate the thin film 12.

Examples of the piezoelectric element 21A composing the vibration generating unit 21 include piezoelectric ceramics such as lead zirconium titanate (PZT). The piezoelectric ceramics generally exhibit a small displacement and thus, are often used in a form of laminate. Further examples include piezoelectric polymers such as polyvinylidene fluoride (PVDF); quartz crystal; and single crystals such as LiNbO₃, LiTaO₃ and KNbO₃.

The vibrating unit 13 may be set in any position, so long as it can vertically vibrate the thin film 12 having nozzles 11. The vibrating surface 13a is placed in parallel with the thin film 12.

In the illustrated example, a horn vibrator is used as the vibrating unit 13 composed of the vibration generating unit 21 and the vibration amplifying unit 22. This horn vibrator can amplify the amplitude of a vibration generated from the vibration generating unit 21 (e.g., a piezoelectric element) using a horn 22A serving as the vibration amplifying unit 22 and thus, an initial vibration generated by the vibration generating unit 21 is allowed to be relatively small. Therefore, the mechanical load can be reduced, resulting in extending the service life of the production apparatus.

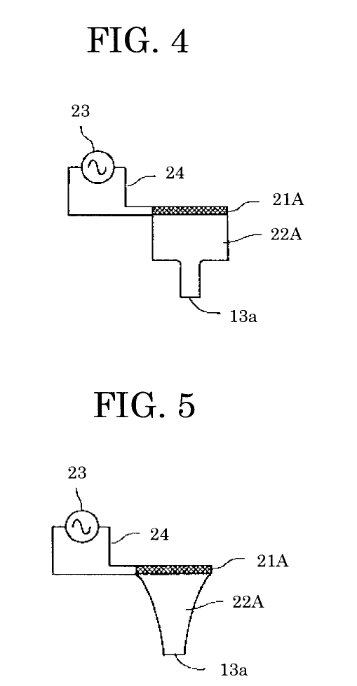

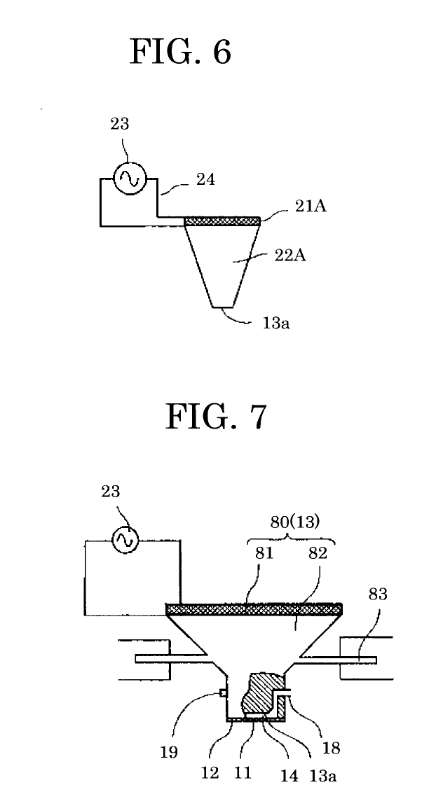

Examples of the horn vibrator include those having a generally known shape. Specific examples include step-horn vibrators (shown in FIG. 4), exponential-horn vibrators (shown in FIG. 5), and conical vibrators (shown in FIG. 6). In each of these horn vibrators, a piezoelectric element 21A is set on a larger surface of the horn 22A, and a smaller surface of the horn 22A serves as a vibrating surface 13a. The piezoelectric element 21A is vertically vibrated and then, the generated vibration is effectively amplified with the horn 22A which is designed so that the vibration amplified becomes the greatest at the vibrating surface 13a. Also, a lead wire 24 is connected to the piezoelectric element 21A at its top and under surfaces, and a drive circuit 23 applies alternating current voltage signals via the lead wire to the piezoelectric element 21A. These horn vibrators are designed so that a vibration becomes the greatest at the vibrating surface 13a.

Further, as the vibrating unit 13, it is also possible to use a bolting Langevin transducer having very high mechanical strength. Even when a high-amplitude vibration is excited, the bolting Langevin transducer will not be broken since a piezoelectric ceramics is mechanically connected thereto.

With reference to a schematic view illustrated in FIG. 2, next will be described in detail the configurations of the reservoir, the mechanically vibrating unit, and the thin film. The reservoir 14 is provided with a liquid feeding tube 18 at one or more sites thereof. As shown in a partial cutaway portion in FIG. 2, a liquid is fed to the reservoir 14 through a flow passage. Further, the reservoir 14 may optionally be provided with an air bubble discharge tube 19. The liquid droplet jetting unit 2 is set and held on the top surface of the particle forming section 3 by an unillustrated support member mounted to the flow passage member 15. Note that the above-described toner production apparatus has the liquid droplet jetting unit 2 placed on the top surface of the particle forming section 3. Alternatively, the toner production apparatus may have such a configuration that the liquid droplet jetting unit 2 is placed on a side wall surface or the bottom of a drying unit which is the particle forming section 3.

In general, the size of the vibrating unit 13 which generates a mechanical vibration increases in accordance with decreasing of the number of vibrations generated. In consideration of the frequency required, the vibrating unit may be directly perforated to form a reservoir. In this case, it is possible to vibrate the entire reservoir with efficiency. Note that the “vibrating surface” is defined as a surface on which the thin film having a plurality nozzles is laminated.

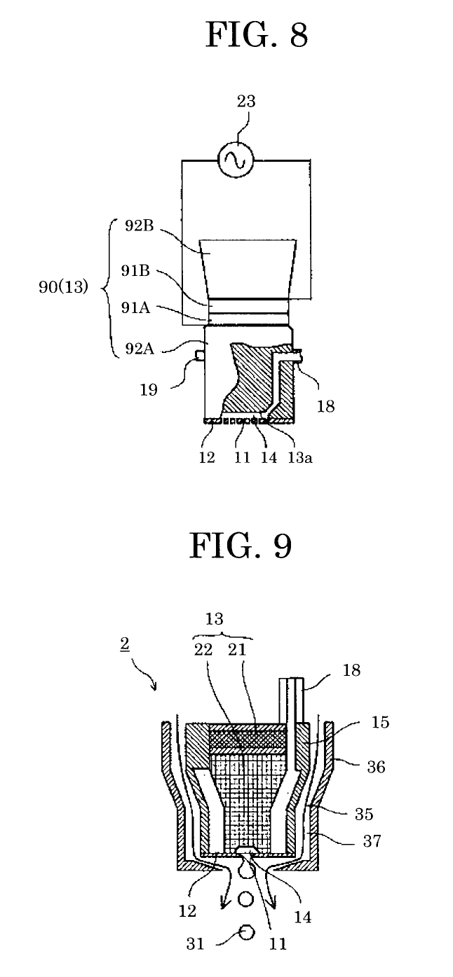

Variant examples of the liquid droplet jetting unit 2 having such a configuration will be described below with reference to FIGS. 7 and 8.

A liquid droplet jetting unit shown in FIG. 7 includes a horn vibrator 80 composed of a piezoelectric element 81 serving as a vibration generating unit and a horn 82 serving as a vibration amplifying unit, wherein the horn vibrator 80 serves as the vibrating unit 80 (13) and a reservoir (flow passage) 14 is formed at part of the horn 82. This liquid droplet jetting unit 2 is preferably fixed on a wall surface of a particle forming section (drying unit) 3 with a fixing part (flange part) 83 which is united with the horn 82 of the horn vibrator 80. Alternatively, the liquid droplet jetting unit 2 may be fixed using an unillustrated elastic material for the purpose of preventing vibration loss.

A liquid droplet jetting unit shown in FIG. 8 includes a bolting Langevin vibrator 90 serving as the vibrating unit 90 (13). The bolting Langevin vibrator 90 is composed of piezoelectric elements 91A and 91B each serving as a vibration generating unit and horns 92A and 93B mechanically and tightly fixed by bolting. In this vibrator, a reservoir (flow passage 14) is formed inside the horn 92A. The size of a piezoelectric element may be large depending on the frequency conditions. In this case, fluid feeding/discharging passages and a reservoir are formed in the vibrator as shown in this figure, and a metal thin film composed of a plurality of thin films may be attached thereto.

The toner production apparatus shown in FIG. 1 has only one liquid droplet jetting unit 2 on the particle forming section 3. From the viewpoint of improving productivity, a plurality of liquid droplet jetting units 2 are arranged in parallel on the top portion of the particle forming section 3 (drying tower). The number of liquid droplet jetting units 2 is preferably 100 to 1,000 from the viewpoint of controllability. In this case, each of the liquid droplet jetting units 2 is designed so that a toner composition liquid 10 is supplied from the material accommodating unit (common liquid reservoir) 7 via the liquid feeding pipe 8 to each reservoir 14. The toner composition liquid 10 may be self-supplied or may be supplied using the pump 9 subsidiarily during operation of the toner production apparatus.

With reference to FIG. 9, another liquid droplet jetting unit will be described below. FIG. 9 is an explanatory cross-sectional view of the liquid droplet jetting unit.

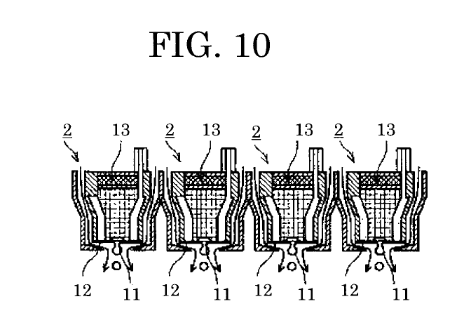

Similar to the above-described liquid droplet jetting units, this liquid droplet jetting unit 2 includes a horn vibrator serving as the vibration generating unit 13. In this liquid droplet jetting unit, a flow passage member 15 for supplying a toner composition liquid 10 is provided so as to surround the vibration generating unit 13, and a reservoir 14 is formed in a horn 22 of the vibration generating unit 13 so as to face a thin film 12. Further, an airflow passage 37 through which an airflow 35 passes is formed between the flow passage member 15 and an airflow passage forming member 36. For the sake of convenience, the thin film 12 having only one nozzle 11 is shown in FIG. 9, but a plurality of nozzles are actually formed as described above. Furthermore, as shown in FIG. 10, a plurality of liquid droplet jetting units—100 to 1,000 liquid droplet jetting units 2 from the viewpoint of, for example, controllability—are arranged on the top surface of a drying tower composing the particle forming section 3. With this configuration, productivity of a toner can be further improved.

### (Film Vibrating Mode Employing Ring-Shaped Mechanically Vibrating Unit)

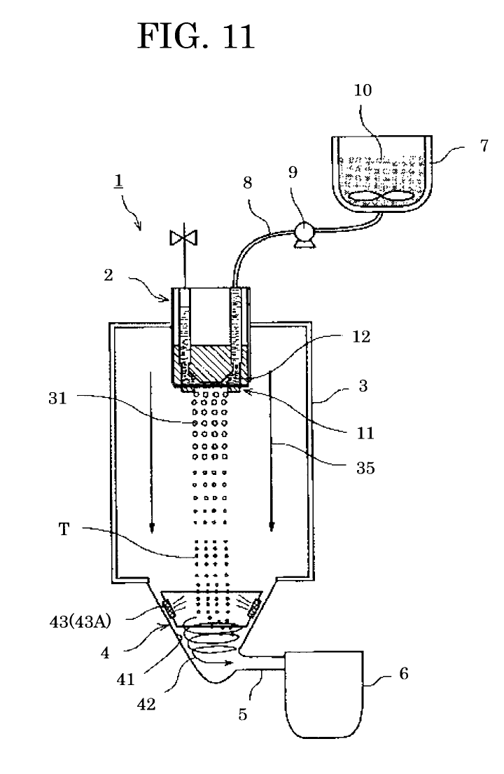

A toner production apparatus shown in FIG. 11 is the same as that shown in FIG. 1, except that a ring-shaped liquid droplet jetting unit is used.

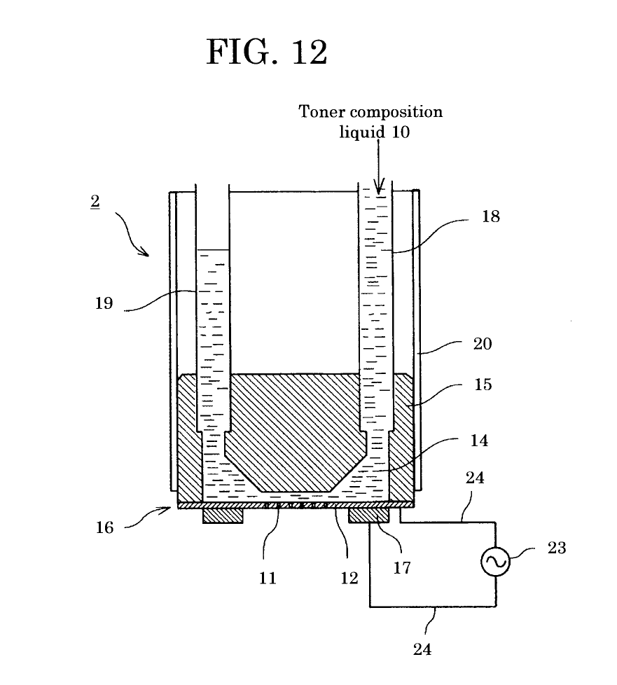

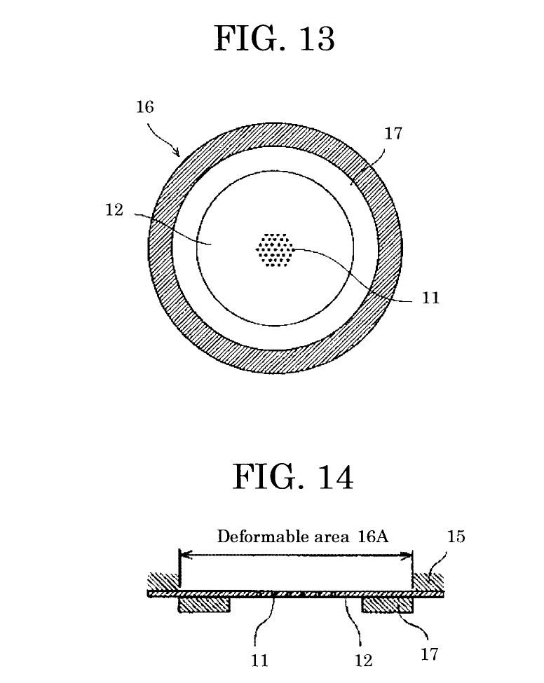

Next will be described a liquid droplet jetting unit 2 with reference to FIGS. 12 to 14. FIG. 12 is an explanatory cross-sectional view of the liquid droplet jetting unit 2; FIG. 13 is a bottom view of the production apparatus shown in FIG. 12, as viewed from the underside; and FIG. 14 is an explanatory schematic cross-sectional view of the liquid droplet forming unit.

This liquid droplet jetting unit 2 includes a liquid droplet forming unit 16 and a flow passage member 15, wherein the liquid droplet forming unit 16 is configured to discharge droplets of the toner composition liquid 10 in the present invention, and the flow passage member 15 has a reservoir (flow passage) 14 for supplying the toner composition liquid 10 to the liquid droplet forming unit 16.

The liquid droplet forming unit 16 has a thin film 12 having a plurality of nozzles (ejection holes) 11 and a ring-shaped vibration generating unit (electromechanical transducing unit) 17 configured to vibrate the thin film 12. Here, the thin film 12 is joined or fixed at its outermost peripheral area (shaded area in FIG. 13) on the flow passage member 15 with solder or a binder resin insoluble in the toner composition liquid. The vibration generating unit 17 is disposed in a deformable area 16A (i.e., area where the flow passage member 15 is not fixed) of the thin film 12 so as to be along a circumference of the area. The vibration generating unit 17 is connected via a lead wire 24 to a drive circuit (drive signal generating source) 23, and when a drive voltage (drive signal) having a required frequency is applied, it generates, for example, deflection vibration.

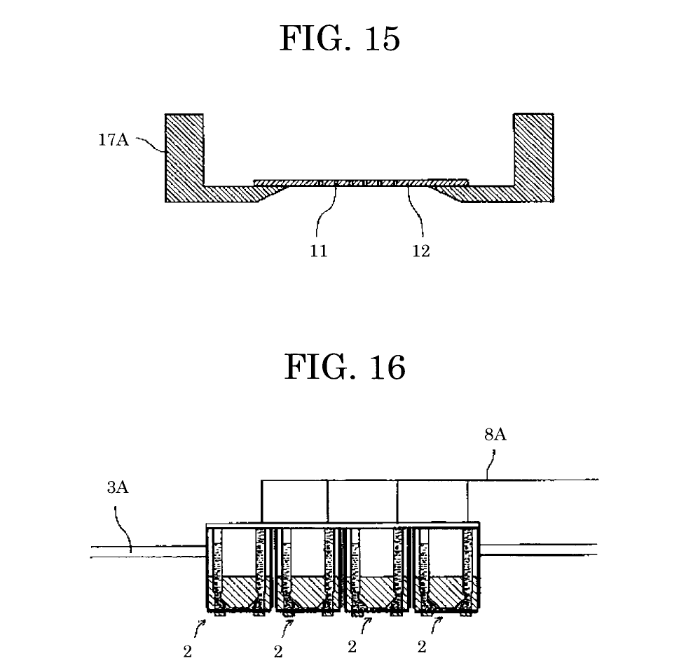

As described above, the liquid droplet forming unit 16 includes the thin film 12 having a plurality of nozzles 11 facing the reservoir 14, and the ring-shaped vibration generating unit 17 disposed in the deformable area 16A so as to surround nozzles of the thin film 12. When the liquid droplet forming unit 16 has such a configuration, as compared with, for example, the comparative configuration shown in FIG. 15 where a vibration generating unit 17A supports the periphery of the thin film 12, the displacement of the thin film 12 is relatively large. With this configuration, a plurality of nozzles 11 can be disposed in a relatively large area (1 mm or greater in diameter) where a large displacement can be obtained and thus, a large number of liquid droplets can be reliably discharged at one time from the nozzles 11.

The toner production apparatus shown in FIG. 11 has one liquid droplet jetting unit 2. Preferably, as shown in FIG. 16, a plurality of liquid droplet jetting units 2 (e.g., 100 to 1,000 liquid droplet jetting units in terms of controllability (in FIG. 16, four liquid droplet jetting units are illustrated)) are disposed in a row to the top surface 3A of the particle forming section 3, and the liquid droplet jetting units 2 are each connected via a pipe 8A to the material accommodating unit 7 (common liquid reservoir) so that the toner composition liquid 10 is supplied thereto. With this configuration, a larger number of liquid droplets can be discharged at one time, resulting in improving production efficiency.

### (Mechanism of Liquid Droplet Formation)

Next will be described a mechanism of liquid droplet formation by the liquid droplet jetting unit 2 serving as a liquid droplet forming unit.

As described above, the liquid droplet jetting unit 2 applies a vibration generated by the vibrating unit 17 serving as a mechanically vibrating unit to the thin film 12 having a plurality of nozzles 11 facing the reservoir 14 to periodically vibrate the thin film 12, whereby liquid droplets are reliably discharged from a plurality of nozzles 11 disposed in a relatively large area (1 mm or greater in diameter).

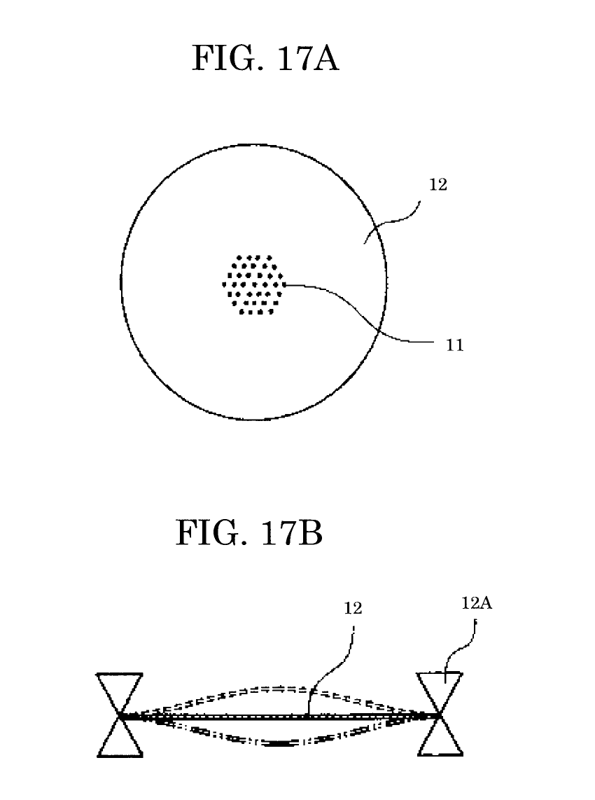

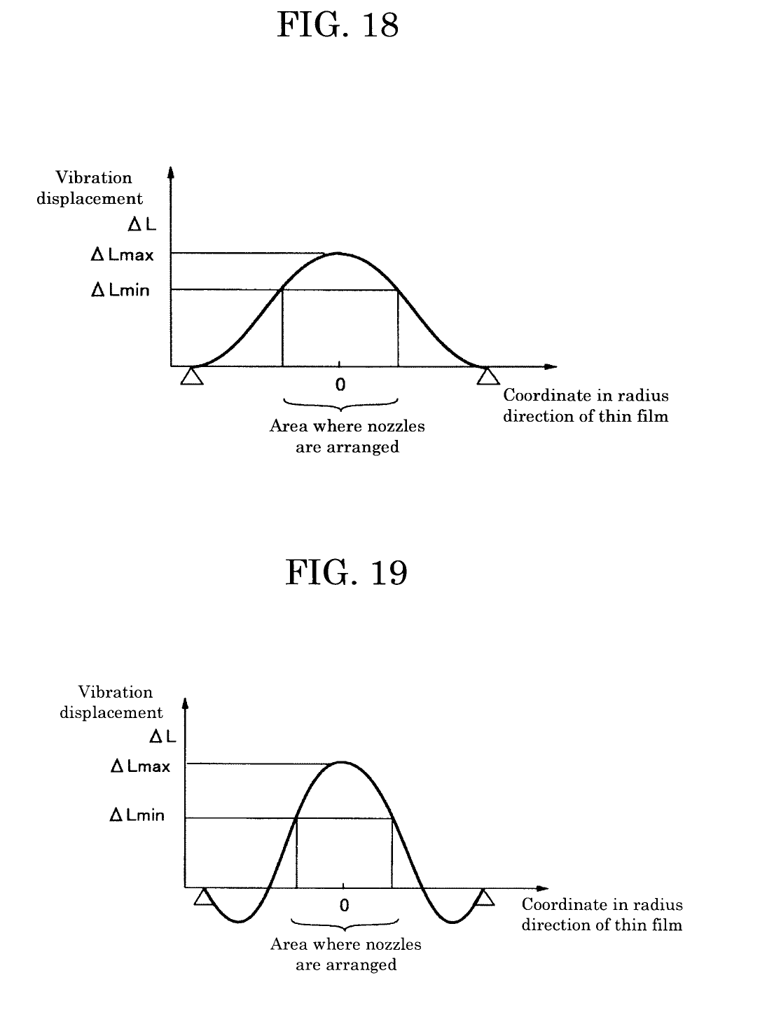

When the thin film 12 having a simple round-shape as shown in FIG. 17A is fixed at its peripheral area 12A, a basic vibration occurring upon vibration has a node at the peripheral area. As shown in FIG. 18, the maximum displacement ΔLmax is observed at a center portion O, and the thin film 12 is periodically vibrated in a vertical direction.

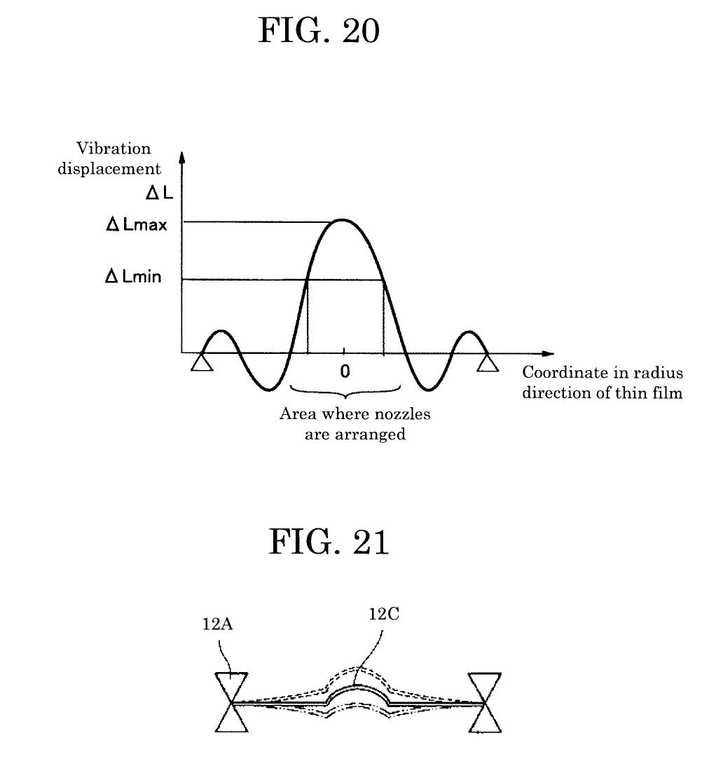

Notably, there have been known higher-order vibration modes shown in FIGS. 19 and 20. In these modes, one or more nodes are concentrically formed in the circular thin film 12, and this thin film substantially transforms axisymmetrically. Also, use of the circular thin film 12 having a convex portion 12c at its center portion (shown in FIG. 21) can control the vibration amplitude and the movement direction of liquid droplets.

When the circular thin film is vibrated, a sound pressure of Pac is applied to the liquid present in the vicinity of the nozzles formed in the circular thin film. This Pac is proportional to a vibration speed Vm of the circular thin film. This sound pressure is known to arise as a result of reaction of a radiation impedance Zr of the medium (toner composition liquid), and is expressed by multiplying the radiation impedance by the film vibration speed Vm, as shown in the following Equation (1).

P_{ac}(r,t)=Zᵣ·Vₘ(r,t) (1)

The film vibration speed Vm periodically varies with time (i.e., is a function of time (t)) and may form various periodic variations (e.g., a sine waveform and rectangular waveform). Also, as described above, the vibration displacement in a vibration direction varies depending on a position in the thin film (i.e., the vibration speed Vm is also a function of a position). As mentioned above, the vibration form of the thin film used in the present invention is axisymmetric. Thus, the vibration form is substantially a function of a radial coordinate (r).

The toner composition liquid is discharged to a gaseous phase by the action of the sound pressure periodically changing proportional to the position-dependent film vibration speed.

Then, the toner composition liquid, which has been periodically discharged to the gaseous phase, becomes spherical attributed to the difference in surface tension between in the liquid phase and in the gaseous phase, whereby liquid droplets thereof are periodically discharged.

In order to form liquid droplets, the thin film 16 may be vibrated at a vibration frequency of 20 kHz to 2.0 MHz, preferably 50 kHz to 500 kHz. When the vibration frequency is 20 kHz or higher, dispersibility of microparticles (e.g., pigment and/or wax particles) contained in the toner composition liquid is promoted through excitation of the toner composition liquid.

Also, when the displacement of the sound pressure is 10 kPa or higher, dispersibility of the above microparticles is further promoted.

Here, the larger the vibration displacement of the film in an area in the vicinity of the nozzles, the larger the diameter of the liquid droplets formed. Meanwhile, when the vibration displacement of the film in an area in the vicinity of the nozzles is small, the formed liquid droplets become small or no liquid droplets are formed. In order to reduce such variation in size of the liquid droplets, the nozzles must be formed in optimal positions determined in consideration of the vibration displacement of the thin film.

Also, the present inventors have found that in the case where the film is vibrated with the mechanical vibrating unit, when nozzles are formed within an area where the ratio R (ΔLₘₐₓ/ΔLₘᵢₙ) of the maximum vibration displacement ΔLₘₐₓ in the vicinity of nozzles to the minimum vibration displacement ΔLₘᵢₙ in the vicinity of nozzles is 2.0 or lower (as shown in FIGS. 18 to 20), variation in size of the liquid droplets is reduced to such an extent that the formed toner particles can provide a high quality image.

As a result of experiments performed by changing the conditions for toner composition liquid, it was found that a range of conditions where a viscosity is set to 20 mPa·s or less and a surface tension is set to 20 mN/m to 75 mN/m is similar to a range of conditions where satellite liquid droplets begin to take place. Thus, the displacement of the sound pressure is preferably 500 kPa or lower, more preferably 100 kPa or lower.

### (Liquid Vibrating Mode Employing Mechanically Vertically Vibrating Unit)

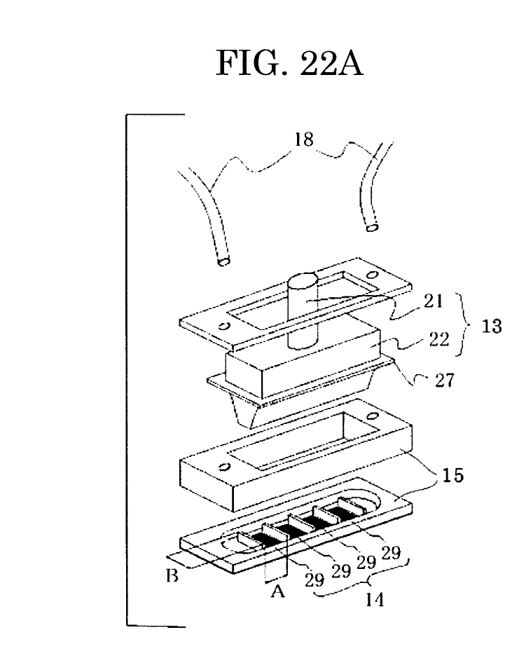

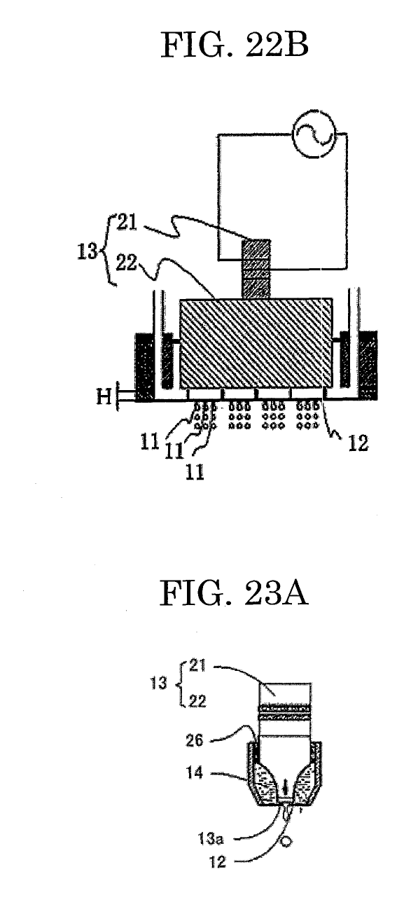

With reference to FIGS. 22A and 22B, next will be described a liquid droplet jetting unit 2 employing a liquid vibrating mode.

FIG. 22B is an explanatory schematic cross-sectional view of the liquid droplet jetting unit 2, and FIG. 22A is an assembly view used for describing the liquid droplet jetting unit 2 in more detail. This liquid droplet jetting unit 2 includes a thin film 12 having a plurality of nozzles (ejection holes) 1, a vibrating unit 13 and a flow passage member 15. The flow passage member forms a reservoir (flow passage) 14 from which the toner composition liquid 10 containing at least a resin, a colorant and a specific releasing agent is fed to a space between the thin film 12 and the vibrating unit 13. The vibrating unit is preferably supported/positioned via a vibration separating member 26 by the inner wall of the reservoir to prevent unnecessary transmission of a vibration. Alternatively, a part 27 of the vibrating unit, the part having a node; i.e., a small vibration amplitude, may be directly fixed on the inner wall of the liquid droplet jetting unit 2. The toner composition liquid 10 is fed through a pipe 18 used for liquid supply/circulation to a liquid reservoir 14. The liquid reservoir 14 is divided into liquid reserving portions 29.

In this liquid vibrating mode, the same units as described in relation to “Film vibrating mode employing mechanically vertically vibrating unit” may be used as a vibrating unit 13 and a vibration amplifying unit 22 in a similar manner.

Partition walls of the liquid reservoir are made of a common material (e.g., metals, ceramics and plastics) that is not dissolved in and modified with a jetting liquid. The aforementioned liquid reservoir 14 is divided into a plurality of liquid reserving portions by the partition walls.

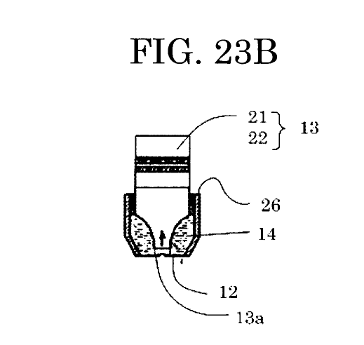

With reference to FIGS. 23A and 23B, next will be described a mechanism of liquid droplet formation by the liquid droplet jetting unit 2 serving as a liquid forming unit. Here, the liquid droplet jetting unit 2 is repeatedly in the state shown in FIG. 23A and in the state shown in FIG. 23B to form liquid droplets. Specifically, a vibration generated on the vibrating surface 13a by the vibrating unit is transmitted to a liquid contained in the reservoir to cause liquid resonance. The liquid is isotropically pressurized and discharged to a gaseous phase from the nozzles of the thin film 12 in the form of liquid droplet. By virtue of this liquid resonance, the liquid is uniformly discharged from all the nozzles. Furthermore, a large amount of microparticles dispersed in the toner composition liquid is not deposited on the thin film surface facing the reservoir (i.e., is maintained to be suspended) and thus, the toner composition liquid can stably jetted for a long period of time.

In this mode, liquid vibration can be attained by adjusting the resonant frequency of liquid lower than that of a structure accommodating the liquid. These resonant frequencies can be measured using a laser Doppler vibrometer. Specifically, the resonant frequency of the liquid can be measured with the vibrometer NLV2500 (product of Polytec Co.) by focusing a laser beam on the meniscus for measuring its oscillation cycle. Meanwhile, the resonant frequency of the structure can be measured with the vibrometer PSV300 (product of Polytec Co.) by focusing a laser beam on the member for measuring its oscillation cycle.

As described above, the film vibrating mode and the liquid vibrating mode use the same vibrating unit. In the film vibrating mode, the film is positively vibrated to generate a sound pressure and then liquid droplets are discharged by the action of the thus-generated sound pressure. In the liquid vibrating mode, the nozzle plate has a thickness about 10 times the thin film used in the film vibrating mode and thus, does not virtually vibrate.

### (Thin Film Having a Plurality of Nozzles)

The thin film having a plurality of nozzles is, as described above, a member for discharging a solution or dispersion of the toner composition in the form of liquid droplet.

The material of the thin film 12 and the shape of the nozzles 11 are not particularly limited and can be appropriately selected. Preferably, the thin film 12 is formed of a metal plate having a thickness of 5 μm to 500 μm and the nozzles 11 each have a circular shape and a pore size of 1 μm to 40 μm, from the viewpoint of forming liquid microdroplets having a very uniform particle diameter when liquid droplets of the toner composition liquid 10 are discharged from the nozzles 11. More preferably, the nozzles 11 each have a pore size of 3 μm to 35 μm. Note that when the nozzles 11 each have a truly circular shape, the pore size is the diameter thereof. Meanwhile, when the nozzles 11 each have an ellipsoidal shape, the pore size is the minor axis thereof. The number of nozzles 11 is preferably 2 to 3,000.

### —Drying—

The drying step (particle forming step) of removing the solvent from liquid droplets through drying is carried out by discharging them in a gas such as heated dry nitrogen gas. If necessary, secondary drying such as fluidized-bed drying and vacuum drying may be carried out.

### Toner

A toner of the present invention is produced with the above-described toner production method of the present invention. The toner produced with this toner production method has a monodisperse particle size distribution. Specifically, the toner preferably has a particle size distribution (mass average particle diameter/number average particle diameter) of 1.00 to 1.15, and preferably has a mass average particle diameter of 1 μm to 20 μm.

This toner can be easily dispersed (i.e., suspended) in an airflow by the action of electrostatic repulsion and thus, can be easily conveyed to a development region with no use of a conveying unit used in conventional electrophotography. Specifically, the toner can be sufficiently conveyed by a weak airflow and thus, can be conveyed to a development region using an air pump having a simple structure for developing. When such toner is used, a latent electrostatic image can be developed in quite good conditions through so-called power cloud development without failure in image formation caused by an airflow. Also, the toner of the present invention can be used in conventional developing processes without involving any problems. In this case, a carrier, a developing sleeve, and other members are used simply as a toner bearing unit, and do not need to contribute to a friction charging mechanism together with a toner. Thus, these carrier and members can be formed of a wider variety of materials and can be considerably improved in durability. In addition, inexpensive materials can be used to reduce production cost therefor.

The toner of the present invention is characterized in that it contains, as a releasing agent, both an acid-modified hydrocarbon wax and an unmodified hydrocarbon wax. Other toner materials than the releasing agent may be the same as materials of conventional electrophotographic toners. Specifically, toner particles of interest can be produced as follows: a binder resin (e.g., a styrene-acrylic resin, a polyester resin, a polyol resin and an epoxy resin) is dissolved in an organic solvent; a colorant is dispersed in the solution and a releasing agent is dispersed (dissolved) in the resultant dispersion; the thus-prepared dispersion is discharged in the form of liquid microdroplet with the above-described toner production method; and the obtained microdroplets are solidified through drying. In an alternative method, the above materials are melt-kneaded; the resultant kneaded product is dissolved or dispersed in a solvent; the thus-prepared dispersion or solution is discharged in the form of liquid microdroplet with the above-described toner production method; and the obtained microdroplets are solidified through drying. Use of both the acid-modified hydrocarbon wax and the unmodified hydrocarbon wax each serving as a releasing agent allows the formed toner to be improved in offset resistance and low-temperature fixing property. In addition, when these waxes are used in combination, the particle diameter of the releasing agent dispersed can be made to be small to prevent crystal growth thereof, resulting in preventing nozzle clogging.

### (Toner Composition)

The toner composition includes at least a binder resin, a colorant, an acid-modified hydrocarbon wax, and an unmodified hydrocarbon wax, the waxes serving as a releasing agent; and, if necessary, includes a charge controlling agent, a magnetic material, a flowability improver, a lubricant, a cleaning aid, a resistivity adjuster and other components.

The toner composition is dissolved or dispersed in a solvent to prepare a toner composition liquid, and the thus-prepared liquid is discharged from nozzles in the form of liquid droplet to produce toner particles.

### (Solvent)

The solvent is preferably organic solvents. The organic solvent is not particularly limited, and preferably has a boiling point lower than 150° C. from the viewpoint of allowing easy solvent removal. Examples thereof include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone and methyl isobutyl ketone. These may be used alone or in combination. The organic solvent preferably has a solubility parameter of 8 (cal/cm³)^{1/2} to 9.8 (cal/cm³)^{1/2}, more preferably 8.5 (cal/cm³)^{1/2} to 9.5 (cal/cm³)^{1/2}, since such organic solvents can dissolve a larger amount of a polyester resin. Among the above organic solvents, ester solvents and ketone solvents are preferred, since these are highly reactive to a modified group of the releasing agent to effectively prevent crystal growth thereof. Particularly, ethyl acetate and methyl ethyl ketone are preferred from the viewpoint of allowing easy solvent removal.

### (Binder Resin)

The binder resin is not particularly limited and can be appropriately selected from commonly used resins. Examples thereof include vinyl polymers formed of, for example, styrene monomers, acrylic monomers and/or methacrylic monomers; homopolymers or copolymers of these monomers; polyester polymers; polyol resins; phenol resins; silicone resins; polyurethane resins; polyamide resins; furan resin; epoxy resins; xylene resins; terpene resin; coumarone-indene resins; polycarbonate resins; and petroleum resins.

Examples of the styrene monomer include styrene and styrene derivatives such as o-methylstyrene, m-methylstyrene, p-methylstyrene, p-phenylstyrene, p-ethylstyrene, 2,4-dimethylstyrene, p-n-amylstyrene, p-tert-butylstyrene, p-n-hexylstyrene, p-n-octylstyrene, p-n-nonylstyrene, p-n-decylstyrene, p-n-dodecylstyrene, p-methoxystyrene, p-chlorostyrene, 3,4-dichlorostyrene, m-nitrostyrene, o-nitrostyrene and p-nitrostyrene.

Examples of the acrylic monomer include acrylic acid and acrylates such as methyl acrylate, ethyl acrylate, propyl acrylate, n-butyl acrylate, isobutyl acrylate, n-octyl acrylate, n-dodecyl acrylate, 2-ethylhexyl acrylate, stearyl acrylate, 2-chloroethyl acrylate and phenyl acrylate.

Examples of the methacrylic monomer include methacrylic acid and methacrylates such as methyl methacrylate, ethyl methacrylate, propyl methacrylate, n-butyl methacrylate, isobutyl methacrylate, n-octyl methacrylate, n-dodecyl methacrylate, 2-ethylhexyl methacrylate, stearyl methacrylate, phenyl methacrylate, dimethylaminoethyl methacrylate and diethylaminoethyl methacrylate.

Examples of other monomers forming the vinyl polymers or copolymers include those listed in (1) to (18) given below:

(1) monoolefins such as ethylene, propylene, butylene and isobutylene; (2) polyenes such as butadiene and isoprene; (3) halogenated vinyls such as vinyl chloride, vinylidene chloride, vinyl bromide and vinyl fluoride; (4) vinyl esters such as vinyl acetate, vinyl propionate and vinyl benzoate; (5) vinyl ethers such as vinyl methyl ether, vinyl ethyl ether and vinyl isobutyl ether; (6) vinyl ketones such as vinyl methyl ketone, vinyl hexyl ketone and methyl isopropenyl ketone; (7) N-vinyl compounds such as N-vinylpyrrole, N-vinylcarbazole, N-vinylindole and N-vinylpyrrolidone; (8) vinylnaphthalenes; (9) acrylic or methacrylic acid derivatives such as acrylonitrile, methacrylonitrile and acrylamide; (10) unsaturated dibasic acids such as maleic acid, citraconic acid, itaconic acid, alkenylsuccinic acid, fumaric acid and mesaconic acid; (11) unsaturated dibasic acid anhydride such as maleic anhydride, citraconic anhydride, itaconic anhydride and alkenylsuccinic anhydride; (12) unsaturated dibasic acid monoesters such as monomethyl maleate, monoethyl maleate, monobutyl maleate, monomethyl citraconate, monoethyl citraconate, monobutyl citraconate, monomethyl itaconate, monomethyl alkenylsuccinate, monomethyl fumarate and monomethyl mesaconate; (13) unsaturated dibasic acid esters such as dimethyl maleate and dimethyl fumarate; (14) α,β-unsaturated carboxylic acids such as crotonic acid and cinnamic acid; (15) α,β-unsaturated carboxylic anhydride such as crotonic anhydride and cinnamic anhydride; (16) carboxyl group-containing monomers such as acid anhydrides formed between α,β-unsaturated carboxylic acids and lower fatty acids; and acid anhydrides and monoesters of alkenylmalonic acid, alkenylglutaric acid and alkenyladipic acid; (17) hydroxyalkyl(meth)acrylate such as 2-hydroxyethyl(meth)acrylate and 2-hydroxypropyl methacrylate; and (18) hydroxy group-containing monomers such as 4-(1-hydroxy-1-methylbutyl)styrene and 4-(1-hydroxy-1-methylhexyl)styrene.

In a toner of the present invention, the vinyl polymer or copolymer serving as a binder resin may have a crosslinked structure formed by a crosslinking agent containing two or more vinyl groups. Examples of the crosslinking agent which can be used for crosslinking reaction include aromatic divinyl compounds (e.g., divinyl benzene and divinyl naphthalene); di(meth)acrylate compounds having an alkyl chain as a linking moiety (e.g., ethylene glycol di(meth)acrylate, 1,3-butylene glycol di(meth)acrylate, 1,4-butanediol di(meth)acrylate, 1,5-pentanediol di(meth)acrylate, 1,6-hexanediol di(meth)acrylate and neopentyl glycol di(meth)acrylate); di(meth)acrylate compounds having, as a linking moiety, an alkyl chain containing an ether bond (e.g., diethylene glycol di(meth)acrylate, triethylene glycol di(meth)acrylate, tetraethylene glycol di(meth)acrylate, polyethylene glycol #400 di(meth)acrylate, polyethylene glycol #600 di(meth)acrylate and dipropylene glycol di(meth)acrylate); di(meth)acrylate compounds having a linking moiety containing an aromatic group or ether bond; and polyester diacrylates (e.g., MANDA (trade name) (product of NIPPON KAYAKU CO., LTD.)).

Examples of multifunctional crosslinking agents which can be used in addition to the above crosslinking agent include pentaerythritol tri(meth)acrylate, trimethylolethane tri(meth)acrylate, trimethylolpropane tri(meth)acrylate, tetramethylolmethane tetra(meth)acrylate, oligoester (meth)acrylate, triallyl cyanurate and triallyl trimellitate.

The amount of the crosslinking agent used is preferably 0.01 parts by mass to 10 parts by mass, more preferably 0.03 parts by mass to 5 parts by mass, per 100 parts by mass of the monomer forming the vinyl polymer or copolymer. Among the above crosslinkable monomers, preferred are aromatic divinyl compounds (in particular, divinyl benzene) and diacrylate compounds having a linking moiety containing one aromatic group or ether bond, since these can impart desired fixing property and offset resistance to the formed toner. Also, copolymers formed between the above monomers are preferably styrene copolymers and styrene-acrylic copolymers.

Examples of polymerization initiators used for producing the vinyl polymer or copolymer in the present invention include 2,2′-azobisisobutylonitrile, 2,2′-azobis (4-methoxy-2,4-dimethylvaleronitrile), 2,2′-azobis (2,4-dimethylvaleronitrile), 2,2′-azobis(2-methylbutylonitrile), dimethyl-2,2′-azobisisobutyrate, 1,1′-azobis(1-cyclohexanecarbonitrile), 2-(carbamoylazo)-isobutylonitrile, 2,2′-azobis(2,4,4-trimethylpentane), 2-phenylazo-2′,4′-dimethyl-4′-methoxyvaleronitrile, 2,2′-azobis (2-methylpropane), ketone peroxides (e.g., methyl ethyl ketone peroxide, acetylacetone peroxide and cyclohexanone peroxide), 2,2-bis (tert-butylperoxy)butane, tert-butyl hydroperoxide, cumene hydroperoxide, 1,1,3,3-tetramethylbutyl hydroperoxide, di-tert-butylperoxide, tert-butyl cumylperoxide, dicumyl peroxide, α-(tert-butylperoxy)isopropylbenzene, isobutyl peroxide, octanoyl peroxide, decanoyl peroxide, lauroyl peroxide, 3,5,5-trimethylhexanoyl peroxide, benzoyl peroxide, m-tolyl peroxide, di-isopropyl peroxydicarbonate, di-2-ethylhexyl peroxydicarbonate, di-n-propyl peroxydicarbonate, di-2-ethoxyethyl peroxycarbonate, di-ethoxyisopropyl peroxydicarbonate, di(3-methyl-3-methoxybutyl)peroxycarbonate, acetylcyclohexylsulfonyl peroxide, tert-butyl peroxyacetate, tert-butylperoxyisobutylate, tert-butylperoxy-2-ethylhexylate, tert-butylperoxylaurate, tert-butyl-oxybenzoate, tert-butylperoxyisopropylcarbonate, di-tert-butylperoxyisophthalate, tert-butylperoxyallylcarbonate, isoamylperoxy-2-ethylhexanoate, di-tert-butylperoxyhexahydroterephthalate and tert-butylperoxyazelate.

When the binder resin is a styrene-acrylic resin, tetrahydrofuran (THF) soluble matter of the resin preferably has such a molecular weight distribution as measured by GPC that at least one peak exists in a range of M.W. 3,000 to M.W. 50,000 (as reduced to a number average molecular weight) and at least one peak exists in a range of M.W. 100,000 or higher, since the formed toner has desired fixing property, offset resistance and storage stability. Preferably, THF soluble matter of the binder resin has a component with a molecular weight equal to or lower than M.W. 100,000 of 50% to 90%, more preferably has a main peak in a range of M.W. 5,000 to M.W. 30,000, most preferably M.W. 5,000 to M.W. 20,000.

When the binder resin is a vinyl polymer such as a styrene-acrylic resin, the acid value thereof is preferably 0.1 mgKOH/g to 100 mgKOH/g, more preferably 0.1 mgKOH/g to 70 mgKOH/g, most preferably 0.1 mgKOH/g to 50 mgKOH/g.

Examples of the monomer forming the polyester polymer include dihydric alcohols such as ethylene glycol, propylene glycol, 1,3-butanediol, 1,4-butanediol, 2,3-butanediol, diethylene glycol, triethylene glycol, 1,5-pentanediol, 1,6-hexanediol, neopentyl glycol, 2-ethyl-1,3-hexanediol, hydrogenated bisphenol A; and diol products formed between bisphenol A and a cyclic ether (e.g., ethylene oxide and propylene oxide).

Alcohols having three or more hydroxyl groups are preferably used for crosslinking reaction of the polyester resin.

Examples of the alcohols having three or more hydroxyl groups include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane and 1,3,5-trihydroxybenzene.

Examples of the acid forming the polyester polymer include benzenedicarboxylic acids (e.g., phthalic acid, isophthalic acid and terephthalic acid) and anhydrides thereof; alkyldicarboxylic acids (e.g., succinic acid, adipic acid, sebacic acid and azelaic acid) and anhydrides thereof; unsaturated dibasic acids (e.g., maleic acid, citraconic acid, itaconic acid, alkenylsuccinic acid, fumaric acid and mesaconic acid; unsaturated dibasic acid anhydrides (e.g., maleic anhydride, citraconic anhydride, itaconic anhydride and alkenylsuccinic anhydride); carboxylic acids having three or more carboxyl groups (e.g., trimellitic acid, pyromellitic acid, 1,2,4-benzenetricarboxylic acid, 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-haxanetricarboxylic acid, 1,3-dicarboxyl-2-methyl-2-methylenecarboxypropane, tetra(methylenecarboxylic)methane, 1,2,7,8-octanetetracarboxylic acid and empol trimer acid); anhydrides of these carboxylic acids having three or more carboxyl groups; and partial alkyl esters of these carboxylic acids having three or more carboxyl groups.

When the binder resin is a polyester resin, THF soluble matter of the resin preferably has such a molecular weight distribution that at least one peak exists in a range of M.W. 3,000 to M.W. 50,000, since the formed toner has desired fixing property and offset resistance. Preferably, THF soluble matter of the binder resin has a component with a molecular weight equal to or lower than M.W. 100,000 of 60% to 100%, more preferably has at least one peak in a range of M.W. 5,000 to M.W. 20,000.

Also, the acid value of the polyester resin is preferably 0.1 mgKOH/g to 100 mgKOH/g, more preferably 0.1 mgKOH/g to 70 mgKOH/g, most preferably 0.1 mgKOH/g to 50 mgKOH/g.

In the present invention, the molecular weight distribution of the binder resin is determined through gel permeation chromatography (GPC) using THF as a solvent.

In the present invention, into at least one of the vinyl polymer and the polyester resin forming the toner, resins having a monomer component capable of reacting therewith may be incorporated. Examples of monomers which form polyester resins and are capable of reacting with a vinyl polymer include unsaturated dicarboxylic acids (e.g., phthalic acid, maleic acid, citraconic acid and itaconic acid) and anhydrides thereof. Examples of monomers forming the vinyl polymer include those having a carboxyl group or hydroxyl group; and (meth)acrylates.

When the polyester polymer, the vinyl polymer and other binder resins are used in combination, the binder resin having an acid value of 0.1 mgKOH/g to 50 mgKOH/g is preferably used in a ratio of 60% by mass or higher of the mixed binder resin.

In the present invention, the acid value of a binder resin contained in a toner composition is measured according to JIS K-0070 as follows:

(1) additives other than a binder resin (polymer component) are removed to prepare a sample, followed by pulverizing, and 0.5 g to 2.0 g of the thus-obtained sample is precisely weighed (W g); (note that when the acid value of the binder resin is measured using an untreated toner sample, a colorant, a magnetic material, etc. other than the binder resin and crosslinked binder resin are separately measured in advance for their content and acid value; and the acid value of the binder resin is calculated based on the thus-obtained value);
(2) the sample is placed in a 300-mL beaker and dissolved using a liquid mixture of toluene/ethanol (4/1 by volume) (150 mL);
(3) the resultant sample solution and a blank sample are titrated with a 0.1 mol/L solution of KOH in ethanol using a potentiometric titrator; and
(4) using the amount (S mL) of the KOH solution consumed for the sample solution and the amount (B mL) of the KOH solution consumed for the blank sample, the acid value of the sample is calculated based on the following equation (2):

Acid value(mgKOH/g)=[(S−B)×f×5.61]/W (2)

where f is a factor of KOH.

The binder resin for toner and the composition containing the binder resin preferably have a glass transition temperature (Tg) of 35° C. to 80° C., more preferably 40° C. to 75° C., from the viewpoint of attaining desired storage stability of the formed toner. When the Tg is lower than 35° C., the formed toner tends to degrade under high temperature conditions and to involve offset during fixing. When the Tg is higher than 80° C., the formed toner may have degraded fixing property.

### (Colorant)

The colorant is not particularly limited and can be appropriately selected from commonly used colorants depending on the purpose. Examples thereof include carbon black, nigrosine dye, iron black, naphthol yellow S, Hansa yellow (10G, 5G and G), cadmium yellow, yellow iron oxide, yellow ocher, yellow lead, titanium yellow, polyazo yellow, oil yellow, Hansa yellow (GR, A, RN and R), pigment yellow L, benzidine yellow (G and GR), permanent yellow (NCG), vulcan fast yellow (5G, R), tartrazinelake, quinoline yellow lake, anthrasan yellow BGL, isoindolinon yellow, colcothar, red lead, lead vermilion, cadmium red, cadmium mercury red, antimony vermilion, permanent red 4R, parared, fiser red, parachloroorthonitro anilin red, lithol fast scarlet G, brilliant fast scarlet, brilliant carmine BS, permanent red (F2R, F4R, FRL, FRLL and F4RH), fast scarlet VD, vulcan fast rubin B, brilliant scarlet G, lithol rubin GX, permanent red F5R, brilliant carmin 6B, pigment scarlet 3B, bordeaux 5B, toluidine Maroon, permanent bordeaux F2K, Helio bordeaux BL, bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, victoria blue lake, metal-free phthalocyanin blue, phthalocyanin blue, fast sky blue, indanthrene blue (RS and BC), indigo, ultramarine, iron blue, anthraquinon blue, fast violet B, methylviolet lake, cobalt purple, manganese violet, dioxane violet, anthraquinon violet, chrome green, zinc green, chromium oxide, viridian, emerald green, pigment green B, naphthol green B, green gold, acid green lake, malachite green lake, phthalocyanine green, anthraquinon green, titanium oxide, zinc flower, lithopone, and mixtures thereof.

The colorant content is preferably 1% by mass to 15% by mass, preferably 3% by mass to 10% by mass, with respect to the toner.

In the present invention, the colorant may be mixed with a resin to form a masterbatch. Examples of the binder resin which is to be kneaded together with a masterbatch include modified or unmodified polyester resins; styrene polymers and substituted products thereof (e.g., polystyrenes, poly-p-chlorostyrenes and polyvinyltoluenes); styrene copolymers (e.g., styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers, styrene-maleic acid ester copolymers); polymethyl methacrylates; polybutyl methacrylates; polyvinyl chlorides; polyvinyl acetates; polyethylenes; polypropylenes, polyesters; epoxy resins; epoxy polyol resins; polyurethanes; polyamides; polyvinyl butyrals; polyacrylic acid resins; rosin; modified rosin; terpene resins; aliphatic or alicyclic hydrocarbon resins; aromatic petroleum resins; chlorinated paraffins; and paraffin waxes. These may be used alone or in combination.

The masterbatch can be prepared by mixing/kneading a colorant with a resin for use in a masterbatch through application of high shearing force. Also, an organic solvent may be used for improving mixing between these materials. Further, the flashing method, in which an aqueous paste containing a colorant is mixed/kneaded with a resin and an organic solvent and then the colorant is transferred to the resin to remove water and the organic solvent, is preferably used, since a wet cake of the colorant can be directly used (i.e., no drying is required to be performed). In this mixing/kneading, a high-shearing disperser (e.g., three-roll mill) is preferably used.

The amount of the masterbatch used is preferably 0.1 parts by mass to 20 parts by mass per 100 parts by mass of the binder resin.

The resin used for forming the masterbatch preferably has an acid value of 30 mgKOH/g or lower and amine value of 1 to 100, more preferably has an acid value of 20 mgKOH/g or lower and amine value of 10 to 50. In use, a colorant is preferably dispersed in the resin. When the acid value is higher than 30 mgKOH/g, chargeability degrades at high humidity and the pigment is insufficiently dispersed. Meanwhile, when the amine value is lower than 1 or higher than 100, the pigment may also be insufficiently dispersed. Notably, the acid value can be measured according to JIS K0070, and the amine value can be measured according to JIS K7237.

Also, a dispersant used preferably has higher compatibility with the binder resin from the viewpoint of attaining desired dispersibility of the pigment. Specific examples of commercially available products thereof include “AJISPER PB821,” AJISPER PB822” (these products are of Ajinomoto Fin-Techno Co., Inc.), “Disperbyk-2001” (product of BYK-chemie Co.) and “EFKA-4010” (product of EFKA Co.).

The dispersant preferably has a mass average molecular weight as measured through gel permeation chromatography of 500 to 100,000, more preferably 3,000 to 100,000, particularly preferably 5,000 to 50,000, most preferably 5,000 to 30,000, from the viewpoint of attaining desired dispersibility of the pigment, wherein the mass average molecular weight is a maximum molecular weight as converted to styrene on a main peak. When the mass average molecular weight is lower than 500, the dispersant has high polarity, potentially degrading dispersibility of the colorant. Whereas when the mass average molecular weight is higher than 100,000, the dispersant has high affinity to a solvent, potentially degrading dispersibility of the colorant.

The amount of the dispersant used is preferably 1 part by mass to 50 parts by mass, more preferably 5 parts by mass to 30 parts by mass, per 100 parts by mass of the colorant. When the amount is less than 1 part by mass, dispersibility may degrade; whereas when the amount is more than 50 parts by mass, chargeability may degrade.

### (Releasing Agent)

In the present invention, in order for the formed toner to have desired low-temperature fixing property and desired offset resistance during fixing, both an acid-modified hydrocarbon wax and an unmodified hydrocarbon wax are added as a releasing agent to the toner composition. Examples of the unmodified hydrocarbon wax include paraffin waxes, sasol waxes and polyolefin waxes (e.g., polyethylene waxes and polypropylene waxes). These may be used alone or in combination. Among them, paraffin waxes, having a low melting point, are preferred, since the formed toner has desired low-temperature fixing property and desired offset resistance.

The method for modifying hydrocarbon waxes is not particularly limited. For example, there can be used the method disclosed in, for example, JP-A Nos. 54-30287, 54-81306, 60-16442, 03-199267 and 2000-10338. Examples of acids used for modifying hydrocarbon waxes include unsaturated polycarboxylic acids and anhydrides thereof (e.g., maleic acid, maleic anhydride, itaconic acid, itaconic anhydride, citraconic acid and citraconic anhydride). Of these, maleic anhydride is preferred, since it has high reactivity and improves dispersibility of the releasing agent.

As mentioned above, when a paraffin wax having a low melting point is used as a hydrocarbon wax, the formed toner can have desired low-temperature fixing property and desired offset resistance. Further, when a modified paraffin wax prepared using maleic anhydride is used in combination, these waxes are finely dispersed to prepare a stable dispersion. In the toner production, when periodically discharged with a mechanical vibrating unit for forming liquid droplets, the thus-prepared toner composition liquid does not cause nozzle clogging. In addition, in each toner particle, finely dispersed acid-modified paraffin wax particles are present in the vicinity of the surface and unmodified paraffin wax particles are present in the vicinity of the center and thus, the formed toner can exhibit more excellent low-temperature fixing property and offset resistance than a toner containing any one of these.

In the toner composition used in the present invention, the ratio A/B of the amount A of the acid-modified hydrocarbon wax (releasing agent) to the amount B of the unmodified hydrocarbon wax (releasing agent) preferably satisfies the relation 0.1≦A/B≦4.0. More preferably, the ratio A/B satisfies the relation 0.3≦A/B≦2.0 from the viewpoints of improving dispensability of the releasing agents and offset resistance of the formed toner. When the ratio A/B is lower than 0.1, the amount of the acid-modified hydrocarbon wax used is small and the releasing agents cannot be sufficiently finely dispersed in the dispersion. Thus, in the toner production, when periodically discharged with a mechanical vibrating unit for forming liquid droplets, the thus-obtained dispersion causes nozzle clogging. Even if nozzle clogging does not occur, the releasing agent is not finely dispersed and thus, a higher proportion of the formed toner particles contains no releasing agent, leading to degradation of fixing property thereof. Also, when toner particles contain large particles of the releasing agent, these large particles are exposed to the toner surface and thus, storage stability is undesirably degraded. When the ratio A/B is higher than 4.0, the amount of the acid-modified hydrocarbon wax used is large and thus, the releasing agents are too finely dispersed in the dispersion although they are sufficiently finely dispersed unlike the case where the ratio A/B is lower than 0.1, resulting in that the formed toner may have degraded offset resistance. A large amount of the acid-modified hydrocarbon wax added and the resin tend to be mutually dissolved since they have a similar polarity. This causes degradation of thermal characteristics of the formed toner, resulting in degradation of offset resistance thereof.

In the present invention, preferably, the sum (A+B) of the amount A of the acid-modified hydrocarbon wax (releasing agent) added to the toner composition and the amount B of the unmodified hydrocarbon wax (releasing agent) added to the toner composition is 0.1 parts by mass to 20 parts by mass, more preferably 0.5 parts by mass to 10 parts by mass, per 100 parts by mass of the binder resin. When the sum A+B is less than 0.1 parts by mass, the releasing agents do not sufficiently exhibit their effects, potentially causing degradation of offset resistance of the formed toner. Whereas when the sum A+B is more than 20 parts by mass, the formed toner may exhibit degraded flowability and/or may adhere to a developing device.

In the present invention, the acid-modified hydrocarbon wax (releasing agent) preferably has an acid value of 1 mgKOH/g to 90 mgKOH/g. More preferably, it has an acid value of 5 mgKOH/g to 50 mgKOH/g, from the viewpoints of attaining sufficient dispersibility of the releasing agent and desired offset resistance of the formed toner. When the acid value is lower than 1 mgKOH/g, dispersibility of the releasing agent is not sufficient, causing nozzle clogging. Even if toner particles are formed, their properties may degrade such as flowability, chargeability and fixing property. Whereas when the acid value is higher than 90 mgKOH/g, wax particles are removed when jetted from nozzles for liquid droplet formation, potentially causing offset resistance of the formed toner. In addition, such a releasing agent is not desirably separated from a polyester resin used, potentially forming a toner having an insufficient offset resistance.

Notably, the acid value is measured using the potentiometric automatic titrator DL-53 (product of Mettler-Toledo K.K.), the electrode DG113-SC (product of Mettler-Toledo K.K.) and the analysis software LabX Light Version 1.00.000. The calibration for this measurement is performed using a solvent mixture of toluene (120 mL) and ethanol (30 mL). The measurement temperature is 23° C., and the measurement conditions are as follows.

Stir

| | |
|---|---|
| Speed [%] | 25 |
| Time [s] | 15 |

EQP titration
Titrant/Sensor

| | |
|---|---|
| Titrant | CH3ONa |
| Concentration [mol/L] | 0.1 |
| Sensor | DG115 |
| Unit of measurement | mV |

Predispensing to volume

| | |
|---|---|
| Volume [mL] | 1.0 |
| Wait time [s] | 0 |

| Titrant addition | Dynamic |
|---|---|
| dE(set) [mV] | 8.0 |
| dV(min) [mL] | 0.03 |
| dV(max) [mL] | 0.5 |

| Measure mode | Equilibrium controlled |
|---|---|
| dE [mV] | 0.5 |
| dt [s] | 1.0 |
| t(min) [s] | 2.0 |
| t(max) [s] | 20.0 |

Recognition

| | |
|---|---|
| Threshold | 100.0 |
| Steepest jump only | No |
| Range | No |
| Tendency | None |

Termination

| | |
|---|---|
| at maximum volume [mL] | 10.0 |
| at potential | No |
| at slope | No |
| after number EQPs | Yes |
| n = 1 | |
| comb. termination conditions | No |

Evaluation

| Procedure | Standard |
|---|---|
| Potential 1 | No |
| Potential 2 | No |
| Stop for reevaluation | No |

Specifically, the acid value is measured according to JIS K0070-1992 as follows. Firstly, a sample (0.5 g) is added to toluene (120 mL), followed by dissolving under stirring at room temperature (23° C.) for about 10 hours and then ethanol (30 mL) is added to the resultant solution. The thus-prepared sample solution is titrated with a pre-standardized 0.1N potassium hydroxide alcohol solution. The acid value is calculated from the thus-obtained titration value X (mL) using the following equation:

Acid value=X×N×56.1/mass of sample(mgKOH/g)

where N is a factor of 0.1N alcohol solution of KOH.

In the present invention, the releasing agent preferably has a melt viscosity as measured at 120° C. of 1 mPa·s to 30 mPa·s, more preferably 1 mPa·s to 10 mPa·s, from the viewpoints of improving fixing property and offset resistance of the formed toner. When the melt viscosity is lower than 1 mPa·s, the formed toner may exhibit degraded flowability; whereas when the melt viscosity is higher than 30 mPa·s, the formed toner may exhibit degraded offset resistance. Note that the melt viscosity is measured using a Brookfield rotary viscometer.

In the present invention, the releasing agent preferably has a melting point of 50° C. to 90° C. Here, the melting point is a temperature at which the maximum amount of heat absorbed by the releasing agent is observed on a DSC curve obtained through differential scanning calorimetry (DSC). As a DSC measurement device, there is preferably used a highly precise differential scanning calorimeter of inner-heat input compensation type. This measurement test is performed according to ASTM D3418-82. The DSC curve used in the present invention is obtained as follows: the temperature of a releasing agent is once raised and then decreased to previously maintain pre-history records therefor; and the temperature of the releasing agent is raised at a temperature increasing rate of 10° C./min. When the melting point of the releasing agent is lower than 50° C., blocking easily occurs during production and storage of the formed toner, potentially degrading heat resistance/storage stability thereof. Whereas when the melting point of the releasing agent is higher than 90° C., the formed toner may exhibit degraded low-temperature fixing property and degraded offset resistance.

### (Magnetic Material)

Examples of the magnetic material which can be used in the present invention include (1) magnetic iron oxides (e.g., magnetite, maghemite and ferrite), and iron oxides containing other metal oxides; (2) metals such as iron, cobalt and nickel, and alloys prepared between these metals and metals such as aluminum, cobalt, copper, lead, magnesium, tin, zinc, antimony, beryllium, bismuth, cadmium, calcium, manganese, selenium, titanium, tungsten and/or vanadium; and (3) mixtures thereof.

Specific examples of the magnetic material include Fe₃O₄, γ-Fe₂O₃, ZnFe₂O₄, Y₃Fe₅O₁₂, CdFe₂O₄, Gd₃Fe₅O₁₂, CuFe₂O₄, PbFe₁₂O, NiFe₂O₄, NdFe₂O, BaFe₁₂O₁₉, MgFe₂O₄, MnFe₂O₄, LaFeO₃, iron powder, cobalt powder, and nickel powder. These may be used alone or in combination. Of these, micropowders of ferrosoferric oxide or γ-iron sesquioxide are preferably exemplified.

Further, magnetic iron oxides (e.g., magnetite, maghemite and ferrite) containing other elements or mixtures thereof can be used. Examples of the other elements include lithium, beryllium, boron, magnesium, aluminum, silicon, phosphorus, germanium, zirconium, tin, sulfur, calcium, scandium, titanium, vanadium, chromium, manganese, cobalt, nickel, copper, zinc and gallium. Of these, magnesium, aluminum, silicon, phosphorus and zirconium are preferred. The other element may be incorporated in the crystal lattice of an iron oxide, may be incorporated into an iron oxide in the form of oxide, or may be present on the surface of an iron oxide in the form of oxide or hydroxide. Preferably, it is contained in the form of oxide.

Incorporation of the other elements into the target particles can be performed as follows: salts of the other elements are allowed to coexist with the iron oxide during formation of a magnetic material, and then the pH of the reaction system is appropriately adjusted. Alternatively, after formation of magnetic particles, the pH of the reaction system may be adjusted with or without salts of the other elements, to thereby precipitate these elements on the surface of the particles.

The amount of the magnetic material used is preferably 10 parts by mass to 200 parts by mass, more preferably 20 parts by mass to 150 parts by mass, based on 100 parts by mass of the binder resins. The number average particle diameter of the magnetic material is preferably 0.1 μm to 2 μm, more preferably 0.1 μm to 0.5 μm. The number average particle diameter of the magnetic material can be measured by observing a magnified photograph thereof obtained through transmission electron microscopy using a digitizer or the like.

For magnetic properties of the magnetic material under application of 10 kOersted, it is preferably to use a magnetic material having an anti-magnetic force of 20 Oersted to 150 Oersted, a saturation magnetization of 50 emu/g to 200 emu/g, and a residual magnetization of 2 emu/g to 20 emu/g. The magnetic material can also be used as a colorant.

### (Charge Controlling Agent)

If necessary, the toner of the present invention may contain a charge controlling agent.

The charge controlling agent may be those known in the art. Examples thereof include Nigrosine dyes, triphenylmethane dyes, chromium-containing metal complex dyes, molybdic acid chelate pigments, Rhodamine dyes, alkoxy-based amines, quaternary ammonium salts (including fluorine-modified quaternary ammonium salts), alkylamide, single substance or compounds of phosphorus, single substance or compounds of tungsten, fluorine-based active agents, metal salicylates, and metal salts of salicylic acid derivatives. Specifically, examples of commercially available products of the charge controlling agent include BONTRON 03 (Nigrosine dye), BONTRON P-51 (quaternary ammonium salt), BONTRON S-34 (metal-containing azo dye), BONTRON E-82 (oxynaphthoic acid metal complex), BONTRON E-84 (salicylic acid metal complex), and BONTRON E-89 (phenolic condensation product), which are manufactured by Orient Chemical Industries, Ltd.; TP-302 and TP-415 (quaternary ammonium salt molybdenum complex), which are manufactured by Hodogaya Chemical Co., LTD.; COPY CHARGE PSY VP2038 (quaternary ammonium salt), COPY BLUE PR (triphenylmethane derivative), COPY CHARGE NEG VP2036 and COPY CHARGE NX VP434, which are manufactured by Hoechst AG; LRA-901, and LR-147 (boron complex), which are manufactured by Japan Carlit Co., Ltd.; copper phthalocyanine, perylene, quinacridone, azo pigments; and polymeric compounds having a functional group such as a sulfonate group, a carboxyl group, or a quaternary ammonium salt group.

In the present invention, the content of the charge controlling agent is determined depending on the type of binder resins used, presence or absence of additives used in accordance with the necessity, and the toner production method including dispersing process and thus is unequivocally defined, however, it is preferably 0.1 parts by mass to 10 parts by mass, more preferably 0.2 parts by mass to 5 parts by mass, per 100 parts by mass of the binder resin When the content of the charge controlling agent is more than 10 parts by mass, the effect of a main charge controlling agent is reduced due to the excessive electrostatic property of the toner, and the electrostatic attraction force to the developing roller used may be increased to cause a degradation in flowability of the developer and a degradation in image density. These charge controlling agents and releasing agents may be melt-kneaded together with the masterbatch and resins or may be added when the binder resins, the colorant and the like are dissolved and dispersed in an organic solvent.

### (Flowability Improver)

A flowability improver may be added in the toner of the present invention. The flowability improver is incorporated onto the surface of the toner to improve the flowability thereof.

Examples of the flowability improver include fluorine-based resin powders such as fluorinated vinylidene fine powder and polytetrafluoroethylene fine powder; silica fine powders such as wet-process silica and dry-process silica; titanium oxide fine powder, alumina fine powder, and surface-treated silica powders, surface-treated titanium oxide and surface-treated alumina each of which is prepared by subjecting titanium oxide fine powder or alumina fine powder to a surface treatment with a silane coupling agent, titanium coupling agent or silicone oil. Of these, silica fine powder, titanium oxide fine powder, and alumina fine powder are preferable. Further, surface-treated silica powders each of which is prepared by subjecting alumina fine powder to a surface treatment with a silane coupling agent or silicone oil are still more preferably used.

The particle size of the flowability improver is, as an average primary particle diameter, preferably 0.001 μm to 2 μm, more preferably 0.002 μm to 0.2 μm.

The silica fine powder is produced by vapor-phase oxidation of a silicon halide compound, is so-called “dry-process silica” or “fumed silica”.

As commercially available products of the silica fine powders produced by vapor-phase oxidation of a silicon halide compound, for example, AEROSIL (trade name, manufactured by Japan AEROSIL Inc.)-130, -300, -380, -TT600, -MOX170, -MOX80 and -COK84; CA-O-SIL (trade name, manufactured by CABOT Corp.) -M-5, -MS-7, -MS-75, -HS-5, -EH-5; Wacker HDK (trade name, manufactured by WACKER-CHEMIE GMBH) -N20, -V15, -N20E, -T30 and -T40; D-C FINE SILICA (trade name, manufactured by Dow Corning Co., Ltd.); and FRANSOL (trade name, manufactured by Fransil Co.).

Further, a hydrophobized silica fine powder prepared by hydrophobizing a silica fine powder produced by vapor-phase oxidation of a silicon halide compound is more preferable. It is particularly preferable to use a silica fine powder that is hydrophobized so that the hydrophobization degree measured by a methanol titration test is preferably from 30% to 80%. A silica fine powder can be hydrophobized by being chemically or physically treated with an organic silicon compound reactive to or physically adsorbed to the silica fine powder, or the like. There is a preferred method, in which a silica fine powder produced by vapor-phase oxidation of a silicon halide compound is hydrophobized with an organic silicon compound.

Examples of the organic silicon compound include hydroxypropyltrimethoxysilane, phenyltrimethoxysilane, n-hexadecyltrimethoxysilane, n-octadecyltrimethoxysilane, vinylmethoxysilane, vinyltriethoxysilane, vinyltriacetoxysilane, dimethylvinylchlorosilane, divinylchlorosilane, γ-methacryloxypropyltrimethoxysilane, hexamethyldisilane, trimethylsilane, trimethylchlorosilane, dimethyldichlorosilane, methyltrichlorosilane, allyldimethylchlorosilane, allylphenyldichlorosilane, benzyldimethylchlorosilane, bromomethyldimethylchlorosilane, α-chloroethyltrichlorosilane, β-chloroethyltrichlorosilane, chloromethyldimethylchlorosilane, triorganosilylmercaptane, trimethylsilylmercaptane, triorganosilylacrylate, vinyldimethylacetoxysilane, dimethylethoxysilane, trimethylethoxysilane, trimethylmethoxysilane, methyltriethoxysilane, isobutyltrimethoxysilane, dimethyldimethoxysilane, diphenyldiethoxysilane, hexamethyldisiloxane, 1,3-divinytetramethyldisiloxane, 1,3-diphenyltetramethyldisiloxane, and dimethylpolysiloxane having 2 to 12 siloxane units per molecule and having 0 to 1 hydroxy group bonded to Si in the siloxane units positioned at the terminals. Further, silicone oils such as dimethylsilicone oil are exemplified. These organic silicon compounds may be used alone or in combination.

The number average particle diameter of the flowability improver is preferably 5 nm to 100 nm, more preferably 5 nm to 50 nm.

The specific surface area of fine powder of the flowability improver measured by the BET nitrogen adsorption method is preferably 30 m²/g or more, more preferably 60 m²/g to 400 m²/g.

In the case of surface treated fine powder of the flowability improver, the specific surface area is preferably 20 m²/g or more, and more preferably 40 m²/g to 300 m²/g.

The amount of the fine powder used is preferably 0.03 parts by mass to 8 parts by mass based on 100 parts by mass of toner particles.

### (Cleanability Improver)

As the cleanability improver for improving removability of residual toner remaining on a latent electrostatic image bearing member and/or a primary transfer member after transferring the toner onto a recording paper sheet or the like, for example, metal salts of fatty acids (e.g., stearic acid), zinc stearate, calcium stearate; and polymer fine particles produced by soap-free emulsion polymerization, such as polymethylmethacrylate fine particles and polystyrene fine particles are exemplified. The polymer fine particles preferably have a relatively narrow particle size distribution and a volume average particle diameter of 0.01 μm to 1 μm.

These flowability improvers, cleanability improvers and the like are used in a state of adhering on or being fixed on the surface of the toner and thus is called “external additives”. Usually, these improvers are externally added to toner using any of powder mixers such as V-type mixer, rocking mixer, LOEDIGE mixer, NAUTA mixer, HENSCHEL mixer. When these improvers are fixed, Hybridizer, Mechanofusion, Q mixer, etc. are used.

### (Carrier)

The toner of the present invention may be used as a two-component developer together with a carrier. As to the carrier, typically used carrier such as ferrite and magnetite and resin-coated carrier can be used.

The resin-coated carrier is composed of carrier core particles and a resin (coating material) coated on the carrier core particles.

Examples of the resin used as the coating material include styrene-acrylic resins such as styrene-acrylic ester copolymers, and styrene-methacrylic ester copolymers; acrylic resins such as acrylic ester copolymers, and methacrylic ester copolymers; fluorine-containing resins such as polytetrafluoroethylene, monochlorotrifluoroethylene polymers, and polyvinylidene fluoride; silicone resins, polyester resins, polyamide resins, polyvinyl butyral, and amino acrylate resins. Besides the above mentioned, resins that can be used as coating materials for carrier such as ionomer resins, and polyphenylene sulfide resins are exemplified. These resins may be used alone or in combination.

In addition, it is possible to use a binder type carrier core in which magnetic powder is dispersed in a resin.

As a method of covering the surface of a carrier core with at least a resin coating material in the resin-coated carrier, the following methods can be used: a method in which a resin is dissolved or suspended to prepare a coating solution or suspension, and the coating solution/suspension is applied over a surface of the carrier core so as to adhere thereon; or a method of mixing a resin in a state of powder.

The mixing ratio of the coating material to the resin-coated carrier is not particularly limited and may be suitably selected in accordance with the intended use. For example, it is preferably 0.01% by mass to 5% by mass, and more preferably 0.1% by mass to 1% by mass with respect to the resin coated carrier.

For usage examples of coating a magnetic material with two or more types of coating material, the following are exemplified: (1) coating a magnetic material with 12 parts by mass of a mixture prepared using dimethyldichlorosilane and dimethyl silicone oil based on 100 parts by mass of titanium oxide fine powder at a mass ratio of 1:5; and (2) coating a magnetic material with 20 parts by mass of a mixture prepared using dimethyldichlorosilane and dimethyl silicone oil based on 100 parts by mass of silica fine powder at a mass ratio of 1:5.

Of these resins, a styrene-methyl methacrylate copolymer, a mixture of a fluorine-containing resin and a styrene-based copolymer, or a silicone resin is preferably used. In particular, silicone resin is preferable.

Examples of the mixture between a fluorine-containing resin and a styrene-based copolymer include a mixture between polyvinylidene fluoride and a styrene-methyl methacrylate copolymer, a mixture between polytetrafluoroethylene and a styrene-methyl methacrylate copolymer, a mixture of vinylidene fluoride-tetrafluoroethylene copolymer (copolymerization mass ratio=10:90 to 90:10), a mixture of styrene-2-ethylhexyl acrylate copolymer (copolymerization mass ratio=10:90 to 90:10); a mixture of styrene-2-ethylhexyl acrylate-methyl methacrylate copolymer (copolymerization mass ratio=20 to 60:5 to 30:10 to 50).

For the silicone resin, nitrogen-containing silicone resins, and modified silicone resins produced through reaction of a nitrogen-containing silane coupling agent and silicone resins are exemplified.

As the magnetic material for carrier core, it is possible to use ferrite, iron-excessively contained ferrite, magnetite, oxide such as γ-iron oxide; or metal such as iron, cobalt, and nickel or an alloy thereof.

Further, examples of elements contained in these magnetic materials include iron, cobalt, nickel, aluminum, copper, lead, magnesium, tin, zinc, antimony, beryllium, bismuth, calcium, manganese, selenium, titanium, tungsten, and vanadium. Of these elements, copper-zinc-iron-based ferrite containing copper, zinc and iron as main components, and manganese-magnesium-iron-based ferrite containing manganese, magnesium, and iron components as main components are particularly preferable.

For the resistance value of the carrier, it is preferable to adjust the degree of irregularities of the carrier surface and the amount of resin used for coating a carrier core so as to be 10⁶ Ω·cm to 10¹⁰ Ω·cm.

The particle diameter of the carrier is preferably 4 μm to 200 μm, more preferably 10 μm to 150 μm, still more preferably 20 μm to 100 μm. In particular, the resin-coated carrier preferably has a D₅₀ particle diameter of 20 μm to 70 μm.

In a two-component developer, the toner of the present invention is preferably used in an amount of 1 part by mass to 200 parts by mass, more preferably 2 parts by mass to 50 parts by mass, per 100 parts by mass of the carrier.

In image developing processes using the toner of the present invention, all of the conventional latent electrostatic image bearing members used in electrophotography can be used. For example, organic latent electrostatic image bearing members, amorphous-silica latent electrostatic image bearing members, selenium latent electrostatic image bearing members and zinc-oxide latent electrostatic image bearing members are suitably used.

### EXAMPLES

The present invention will next be described in detail by was of Examples, which should not be construed as limiting the present invention thereto. Notably, unless otherwise specified, the units “part(s)” and “%” are “part(s) by mass” and “% by mass,” respectively.

### Production Example of Acid-Modified Hydrocarbon Wax

A reaction vessel equipped with a stirring rod and a thermometer was charged with an unmodified paraffin wax (HNP-11, product of NIPPON SEIRO CO., LTD.) (100 parts), followed by heating to 150° C. using a heater, to thereby melt the wax. Subsequently, maleic anhydride and di-t-butyl peroxide (organic peroxide) were dissolved in toluene, and the thus-prepared solution was added dropwise to the reaction vessel. Then, the resultant mixture was allowed to react for 5 hours under stirring. After completion of reaction, the reaction vessel was purged with nitrogen, followed by removal of toluene, to thereby synthesize modified paraffin wax A. The thus-synthesized modified paraffin wax A was found to have a melting point of 69° C., acid value of 20 mgKOH/g, and melt viscosity as measured at 120° C. of 10 mPa·s.

Separately, the above procedure was repeated, except that the amount of the solution added and the reaction time were appropriately adjusted, to thereby synthesize modified paraffin wax B having a melting point of 75° C., acid value of 80 mgKOH/g, and melt viscosity as measured at 120° C. of 20 mPa·s.

### Example 1

### Preparation of Colorant Dispersion

First, a dispersion of carbon black (colorant) was prepared.

Specifically, carbon black (Regal 400, product of Cabot Corporation) (20 parts by mass) and a pigment dispersant (AJISPER PB821, product of Ajinomoto Fin-Techno Co., Inc.) (2 parts by mass) were primarily dispersed in ethyl acetate (78 parts by mass) using a mixer having an impeller. The resultant primary dispersion was more finely dispersed through application of strong shearing force using a DYNO-MILL to prepare a secondary dispersion containing no aggregates. The resultant secondary dispersion was caused to pass through a PTFE filter having a pore size of 0.45 μm to prepare a dispersion containing submicron particles.

### Preparation of Dispersion Containing Resin and Wax

A container equipped with an impeller and a thermometer was charged with a polyester resin (binder resin) (mass average molecular weight: 20,000) (200 parts by mass), modified paraffin wax A (8 parts by mass), the unmodified paraffin wax (melt viscosity as measured at 120° C.: 15 mPa·s) (8 parts by mass), and ethyl acetate (2,000 parts by mass). The mixture was heated to 85° C. and stirred for 20 min, to thereby dissolve the polyester resin, the modified paraffin wax, and the unmodified paraffin wax. The solution was quenched to precipitate microparticles of the modified paraffin wax and the unmodified paraffin wax. The resultant dispersion was more finely dispersed through application of strong shearing force using a DYNO-MILL.

### Preparation of Toner Composition Liquid

The above-prepared carbon black dispersion (30 parts by mass) and the above-prepared resin/wax-containing dispersion (1,100 parts by mass) were mixed with each other using a mixer having an impeller.

The obtained toner composition liquid was diluted with ethyl acetate so that the solid content thereof was adjusted to 6.0%, to thereby prepare a toner composition liquid.

### Production of Toner

The above-prepared toner composition liquid was fed to the head of a ring-shaped vibrator in a toner production apparatus illustrated in FIG. 11.

The thin film used was a nickel film (outer diameter: 8.0 mm, thickness: 20 μm) having truly spherical ejection holes (nozzles) (diameter: 8 μm), which was produced through electroforming. The ejection holes were arranged in a lattice form only within a circle having the center of the film and a diameter of about 5 mm so that the interdistance therebetween was adjusted to 100 μm. The piezoelectric element used was a laminated lead zirconium titanate (PZT), which was used at a vibration frequency of 100 KHz.

Under the following toner production conditions, the above-prepared toner composition liquid was discharged as liquid droplets, followed by solidification through drying, to thereby produce toner base particles.

### [Toner Production Conditions]

Flow rate of dry air: nitrogen gas for dispersion: 2.0 L/min; dry nitrogen gas in apparatus: 30.0 L/min

Internal temperature of apparatus: 27° C. to 28° C.

Dew-point temperature: −20° C.

Vibration frequency of nozzles: 98 kHz

Solidified particles after drying were collected with a filter having a pore size of 1 μm through suction. Subsequently, hydrophobic silica (H2000, product of Clariant Japan K.K.) (1.0% by mass) was externally added to the thus-collected particles, and then the mixture was treated with a Henschel mixer (product of Mitsui Mining Co.) to produce black toner a. When measured for its particle size distribution, the thus-produced toner was found to have a mass average particle diameter (D4) of 5.3 μm, and a D4/Dn of 1.02; i.e., a very sharp particle size distribution.

This toner production was performed for 5 consecutive hours without nozzle clogging.

### Production of Carrier

Silicone resin (organo straight silicone): 100 parts

Toluene: 100 parts

γ-(2-Aminoethyl)aminopropyltrimethoxysilane: 5 parts

Carbon black: 10 parts

The above-listed components were mixed with one another, and the resultant mixture was dispersed using a homomixer for 20 min to prepare a coat layer-forming liquid. The thus-prepared liquid was applied onto spherical magnetite (particle diameter: 50 μm) (1,000 parts) using a fluidized bed coater, to thereby produce magnetic carrier A.

### Production of Developer

Tone a (4 parts) and magnetic carrier A (96 parts) were mixed with each other using a ball mill to produce two-component developer 1. The thus-produced developer 1 was evaluated for its cold offset property, hot offset property, and filming property. As shown in Table 1, two-component developer 1 was found to exhibit good cold offset property, good hot offset property, and good filming property.

Each evaluation was performed as follows.

### [Evaluation Method]

### Particle Size Distribution

The mass average particle diameter (D4) and the number average particle diameter (Dn) were obtained as follows: a toner sample was subjected to measurement using a particle size analyzer (Multisizer III, product of Beckman Coulter Co.) with the aperture diameter being set to 100 μm, and the obtained measurements were analyzed with analysis software (Beckman Coulter Multisizer 3 Version 3.51). Specifically, a 10% by mass surfactant (alkylbenzene sulfonate, Neogen SC-A, product of Daiichi Kogyo Seiyaku Co.) (0.5 mL) was added to a 100 mL-glass beaker, and a toner sample (0.5 g) was added thereto, followed by stirring with a microspartel. Subsequently, ion-exchange water (80 mL) was added to the beaker, and the obtained dispersion was dispersed with an ultrasonic wave disperser (W-113MK-II, product of Honda Electronics Co.) for 10 min. The resultant dispersion was measured using the above Multisizer III and Isoton III (product of Beckman Coulter Co.) serving as a solution for measurement. The dispersion containing the toner sample was dropped so that the concentration indicated by the meter fell within a range of 8%±2%. Notably, in this method, it is important that the concentration is adjusted to 8%±2%, considering attaining measurement reproducibility with respect to the particle diameter. No measurement error is observed, so long as the concentration falls within the above range. Notably, in this measurement, 13 channels were used: 2.00 μm (inclusive) to 2.52 μm (exclusive); 2.52 μm (inclusive) to 3.17 μm (exclusive); 3.17 μm (inclusive) to 4.00 μm (exclusive); 4.00 μm (inclusive) to 5.04 μm (exclusive); 5.04 μm (inclusive) to 6.35 μm (exclusive); 6.35 μm (inclusive) to 8.00 μm (exclusive); 8.00 μm (inclusive) to 10.08 μm (exclusive); 10.08 μm (inclusive) to 12.70 μm (exclusive); 12.70 μm (inclusive) to 16.00 μm (exclusive); 16.00 μm (inclusive) to 20.20 μm (exclusive); 20.20 μm (inclusive) to 25.40 μm (exclusive); 25.40 μm (inclusive) to 32.00 μm (exclusive); and 32.00 μm (inclusive) to 40.30 μm (exclusive); i.e., particles having a particle diameter of 2.00 μm (inclusive) to 40.30 μm (exclusive) were subjected to the measurement. Based on the measured volume and number of the toner particles (toner), the corresponding volume distribution and number distribution are calculated. The mass average particle diameter (D4) and the number average particle diameter (Dn) of the toner can be calculated from these volume distribution and number distribution. As a measure for particle size distribution, there is used the ratio D4/Dn of the mass average particle diameter of the toner (D4) to the number average particle diameter of the toner (Dn). When the toner has a monodisperse distribution, the ratio D4/Dn is 1. The larger the ratio D4/Dn of the toner, the broader the particle size distribution thereof.

### Cold Offset Property

A fixing portion of the copier MF-200 (product of Ricoh Company, Ltd.) employing a TEFLON (registered trade mark) roller as a fixing roller was modified to produce a modified copier. A developer and Type 6000 paper sheets (product of Ricoh Company, Ltd.) were set in the modified copier, and printing test was performed while changing the temperature of the fixing roller in 5° C. steps. Subsequently, a pat was rubbed against the obtained fixed images. The cold offset property of a toner contained in the developer was evaluated based on the minimum fixing temperature; i.e., a temperature of the fixing roller at which the image density of the thus-rubbed image was 70% or higher. The minimum fixing temperature is preferably lower from the viewpoint of reducing power consumption. Toners having a minimum fixing temperature of 135° C. or lower are practically applicable. The minimum fixing temperature (i.e., cold offset-occurring temperature) of the toner was measured and evaluated according to the following evaluation criteria:

A: Minimum fixing temperature<130° C.;
B: 130° C.≦minimum fixing temperature<140° C.; and
C: 140° C.≦minimum fixing temperature.

The results are shown in Table 1.

### Hot Offset Property

A developer and Type 6000 paper sheets (product of Ricoh Company, Ltd.) were set in a commercially available copier (imagio Neo 455, product of Ricoh Company, Ltd.). Images were formed/output while gradually increasing the fixing temperature. The offset-occurring temperature was defined as a temperature at which glossiness of the formed image degraded or at which an offset image was observed in the formed image. The offset-occurring temperature of the toner contained in the developer was measured and evaluated according to the evaluation following criteria:

A: 200° C.<offset-occurring temperature;
B: 190° C.<offset-occurring temperature<200° C.; and
C: Offset-occurring temperature<190° C.

The results are shown in Table 1.

### Filming Property

A developer and Type 6000 paper sheets (product of Ricoh Company, Ltd.) were set in a commercially available copier (imagio Neo 455, product of Ricoh Company, Ltd.), and images with an image area ratio of 7% were printed out. After printing of 20,000 sheets, 50,000 sheets or 100,000 sheets, filming on the photoconductor and formation of an abnormal image (uneven density in a halftone image portion) caused by filming were evaluated according to the following evaluation criteria:

A: No filming occurred even after printing of 100,000 sheets;
B: Filming occurred at the time when 50,000 sheets were printed; and
C: Filming occurred at the time when 20,000 sheets were printed.

The results are shown in Table 1. Note that as the number of printing increases, filming is more observed.

### Example 2

The toner composition liquid produced in Example 1 was fed to the head of a horn vibrator in a toner production apparatus illustrated in FIG. 1.

The thin film used was a nickel film (outer diameter: 8.0 mm, thickness: 20 μm) having truly spherical ejection holes (diameter: 10 μm), which was produced through electroforming. The ejection holes were arranged in a lattice form only within a circle having the center of the thin film and a diameter of about 5 mm so that the interdistance therebetween was adjusted to 100 μm. In this case, the effective number of ejection holes was about 1,000.

Under the following toner production conditions, the toner composition liquid was discharged as liquid droplets, followed by solidification through drying, to thereby produce toner base particles.

### [Toner Production Conditions]

Flow rate of dry air: nitrogen gas for dispersion: 2.0 L/min; dry nitrogen gas in apparatus: 30.0 L/min

Inlet temperature of drying tower: 60° C.

Outlet temperature of drying tower: 45° C.

Dew-point temperature: −20° C.

Drive frequency: 180 kHz

Solidified particles after drying were collected with a filter having a pore size of 1 μm through suction. Subsequently, hydrophobic silica (H2000, product of Clariant Japan K.K.) (1.0% by mass) was externally added to the thus-collected particles, and then the mixture was treated with a Henschel mixer (product of Mitsui Mining Co.) produce black toner b.

When measured for its particle size distribution, the thus-produced toner was found to have a mass average particle diameter (D4) of 5.3 μm, and a D4/Dn of 1.02; i.e., a very sharp particle size distribution.

This toner production was performed for 5 consecutive hours without nozzle clogging.

Similar to Example 1, black toner b and the same carrier were mixed with each other to produce a developer, and then the thus-produced developer was evaluated for its cold offset property, hot offset property, and filming property. As shown in Table 1, the developer was found to exhibit good cold offset property, good hot offset property, and good filming property.

### Example 3

The procedure of Example 2 was repeated, except that the ratio of the amount of modified paraffin wax A and that of unmodified paraffin wax was changed from 1.0 to 0.1, to thereby produce toner c.

When measured for its particle size distribution, the thus-produced toner was found to have a mass average particle diameter (D4) of 5.0 μm, and a D4/Dn of 1.05; i.e., a very sharp particle size distribution.

Although this toner production was performed for 5 consecutive hours without nozzle clogging, the amount of liquid droplets discharged tended to be slightly decreased after 4 hours from the beginning of toner production.

Similar to Example 1, toner c and the same carrier were mixed with each other to produce a developer, and then the thus-produced developer was evaluated for its cold offset property, hot offset property, and filming property. As shown in Table 1, the developer was found to exhibit good cold offset property, but to exhibit slightly poor hot offset property and filming property.

### Example 4

The procedure of Example 2 was repeated, except that the ratio of the amount of modified paraffin wax A and that of unmodified paraffin wax was changed from 1.0 to 4.0, to thereby produce toner d.

When measured for its particle size distribution, the thus-produced toner was found to have a mass average particle diameter (D4) of 4.8 μm, and a D4/Dn of 1.01; i.e., a very sharp particle size distribution.

Note that this toner production was performed for 5 consecutive hours without nozzle clogging.

Similar to Example 1, toner d and the same carrier were mixed with each other to produce a developer, and then the thus-produced developer was evaluated for its cold offset property, hot offset property, and filming property. As shown in Table 1, the developer was found to exhibit good cold offset property and good filming property, but to exhibit slightly poor hot offset property.

### Example 5

The procedure of Example 2 was repeated, except that modified paraffin wax A was changed to modified paraffin wax B, to thereby produce toner e.

When measured for its particle size distribution, the thus-produced toner was found to have a mass average particle diameter (D4) of 5.3 μm, and a D4/Dn of 1.04; i.e., a very sharp particle size distribution.

Note that this toner production was performed for 5 consecutive hours without nozzle clogging.

Similar to Example 1, toner e and the same carrier were mixed with each other to produce a developer, and then the thus-produced developer was evaluated for its cold offset property, hot offset property, and filming property. As shown in Table 1, the developer was found to exhibit good cold offset property, good hot offset property, and good filming property.

### Example 6

The toner composition liquid prepared in Example 1 was fed to a liquid droplet jetting unit 2 employing a liquid vibrating mode shown in FIG. 22B. The ejection holes (nozzles) were arranged in a lattice form so that the interdistance therebetween was adjusted to 100 μm. The liquid reservoir used was equally divided into liquid reserving portions. The excitation frequency and the configuration of the liquid reserving portion used in this Example are as follows. Notably, a sine waveform voltage was applied to the vibrating unit, and only one liquid droplet jetting unit shown in FIG. 22B was used for evaluation.

The nozzle plate used was made of silicon and had a thickness of 400 μm.

The resonant frequency of liquid was found to be 32.7 kHz, and the resonant frequency of a structure having a member constituting the reservoir and the nozzle plate was found to be 74 kHz.

### Configuration of Liquid Reserving Portion and Drive Frequency

Excitation frequency: 32.7 kHz

Number of liquid reserving portions forming liquid reservoir: 6

Length of each liquid reserving portion in a longer direction A: 8 mm

Length of each liquid reserving portion in a shorter direction B: 8 mm

Number of nozzles per one liquid reserving portion: 480

The toner composition liquid was discharged as liquid droplets with the flow rate of dry nitrogen gas in the apparatus being set to 30.0 L/min, followed by solidification through drying, to thereby produce toner base particles.

Solidified particles after drying were collected with a filter having a pore size of 1 μm through suction. Subsequently, hydrophobic silica (H2000, product of Clariant Japan K.K.) (1.0% by mass) was externally added to the thus-collected particles, and then the mixture was treated with a Henschel mixer (product of Mitsui Mining Co.) to produce black toner h.

When measured for its particle size distribution, the thus-produced toner was found to have a mass average particle diameter (D4) of 5.5 μm, and a D4/Dn of 1.01; i.e., a very sharp particle size distribution.

This toner production was performed for 5 consecutive hours without nozzle clogging.

Similar to Example 1, toner h and the same carrier were mixed with each other to produce a developer, and then the thus-produced developer was evaluated for its cold offset property, hot offset property, and filming property. As shown in Table 1, the developer was found to exhibit good cold offset property, good hot offset property, and good filming property.

### Comparative Example 1

There was prepared a toner composition liquid that was the same as the toner composition liquid used in Example 2, except that only the unmodified paraffin wax was used as a releasing agent. The procedure of Example 2 was repeated, except that the thus-prepared toner composition liquid was used. As a result, a toner could not be produced due to nozzle clogging. Needless to say, the evaluation could not be performed.

### Comparative Example 2

There was prepared a toner composition liquid that was the same as the toner composition liquid used in Example 2, except that only the modified paraffin wax A was used as a releasing agent. The procedure of Example 2 was repeated, except that the thus-prepared toner composition liquid was used, to thereby produce toner f.

When measured for its particle size distribution, the thus-produced toner was found to have a mass average particle diameter (D4) of 4.7 μm, and a D4/Dn of 1.05; i.e., a very sharp particle size distribution.

Note that this toner production was performed for 5 consecutive hours without nozzle clogging, and jettability of liquid droplets was found to be very good.

Similar to Example 1, toner f and the same carrier were mixed with each other to produce a developer, and then the thus-produced developer was evaluated for its cold offset property, hot offset property, and filming property. As shown in Table 1, the developer was found to exhibit good cold offset property, but to exhibit poor hot offset property and poor filming property.

### Comparative Example 3

The toner composition liquid prepared in Comparative Example 2 was sprayed in a nitrogen atmosphere at 45° C. from a two-fluid spray nozzle having a diameter of 250 μm with the air pressure being set to 0.1 MPa. The formed particles were collected using a cyclone and air-dried at 40° C. for 3 days, whereby toner base particles were produced. Subsequently, hydrophobic silica (H2000, product of Clariant Japan K.K.) (1.0% by mass) was externally added to the thus-produced toner base particles to produce black toner g.

When measured for its particle size distribution, the thus-produced toner was found to have a mass average particle diameter (D4) of 7.8 μm, and a D4/Dn of 1.87; i.e., a very broad particle size distribution. Thus, the evaluation for the toner was not performed.

### Comparative Example 4

The toner composition liquid prepared in Comparative Example 1 was fed to a liquid droplet jetting unit 2 employing a liquid vibrating mode illustrated in FIG. 22B for producing toner particles. As a result, a toner could not be produced due to nozzle clogging. Needless to say, the evaluation could not be performed.

### Comparative Example 5

Under the same conditions as Example 6, the toner composition liquid prepared in Comparative Example 2 was fed to a liquid droplet jetting unit 2 employing a liquid vibrating mode illustrated in FIG. 22B, to thereby produce toner 1.

When measured for its particle size distribution, the thus-produced toner was found to have a mass average particle diameter (D4) of 4.9 μm, and a D4/Dn of 1.03; i.e., a very sharp particle size distribution.

This toner production was performed for 5 consecutive hours without nozzle clogging, and jettability of liquid droplets was found to be very good.

Similar to Example 1, toner i and the same carrier were mixed with each other to produce a developer, and then the thus-produced developer was evaluated for its cold offset property, hot offset property, and filming property. As shown in Table 1, the developer was found to exhibit good cold offset property, but to exhibit poor hot offset property and slightly poor filming property.

TABLE 1

| | | | | Mass average | | | | |
|---|---|---|---|---|---|---|---|---|
| | | Acid-modified wax/ | | particle diameter | | | | |
| | Toner | unmodified wax | Nozzle clogging | D4 (μm) | D4/Dn | Cold offset | Hot offset | Filming |
| Ex. 1 | Toner a | 1.0 | No clogging occurred | 5.3 | 1.02 | A | A | A |
| Ex. 2 | Toner b | 1.0 | No clogging occurred | 5.3 | 1.02 | A | A | A |
| Ex. 3 | Toner c | 0.1 | Clogging slightly occurred | 5.0 | 1.05 | A | B | B |
| Ex. 4 | Toner d | 4.0 | No clogging occurred | 4.8 | 1.01 | A | B | A |
| Ex. 5 | Toner e | 1.0 | No clogging occurred | 5.3 | 1.04 | A | A | A |
| Ex. 6 | Toner h | 1.0 | No clogging occurred | 5.5 | 1.01 | A | A | A |
| Comp. Ex. 1 | — | Only unmodified | Clogging occurred | — | — | Toner was not produced | | |
| | | wax added | | | | | | |
| Comp. Ex. 2 | Toner f | Only acid-modified | No clogging occurred | 4.7 | 1.05 | A | C | C |
| | | wax added | | | | | | |
| Comp. Ex. 3 | Toner g | Only acid-modified | No clogging occurred | 7.8 | 1.87 | Evaluation was not performed, | | |
| | | wax added | | | | since the produced toner had | | |
| | | | | | | ununiform particle size distribution | | |
| Comp. Ex. 4 | — | Only unmodified | Clogging occurred | — | — | Toner was not produced | | |
| | | wax added | | | | | | |
| Comp. Ex. 5 | Toner i | Only acid-modified | No clogging occurred | 4.9 | 1.03 | A | C | C |
| | | wax added | | | | | | |

The toner produced with the toner production method of the present invention has an excellent monodispersibility, low-temperature fixing property and offset resistance; and can consistently form a high-resolution, high-definition, high-quality image over a long period of time. Thus, it can be suitably used in a developer for developing a latent electrostatic image in, for example, electrophotography, electrostatic recording and electrostatic printing.

What is claimed is:

1. A method for producing a toner, the method comprising:
discharging a toner composition liquid from a plurality of nozzles to form liquid droplets thereof, the toner composition liquid being prepared by dissolving or dispersing in a solvent a toner composition containing at least a binder resin, a colorant, an acid-modified hydrocarbon wax and an unmodified hydrocarbon wax, the waxes serving as a releasing agent, and
solidifying the liquid droplets so as to form solid particles.

2. The method according to claim 1, wherein the discharging is periodically discharging the toner composition liquid from the nozzles, while a thin film having the nozzles is vibrated.

3. The method according to claim 2, wherein the thin film is disposed in a reservoir for the toner composition liquid, and the periodically discharging is discharging the toner composition liquid from the nozzles by vibrating the thin film using a mechanically vibrating unit.

4. The method according to claim 3, wherein the mechanically vibrating unit is a ring-shaped vibration generating unit disposed on the thin film so as to surround an area where the nozzles are arranged.

5. The method according to claim 3, wherein the mechanically vibrating unit is a vibrating unit having a vibrating surface disposed in parallel with the thin film, and the vibrating surface vertically vibrates in a perpendicular direction to the thin film.

6. The method according to claim 5, wherein the mechanically vibrating unit is a horn vibrator.

7. The method according to claim 3, wherein the mechanically vibrating unit vibrates at a vibration frequency of 20 kHz or higher and lower than 2.0 MHz.

8. The method according to claim 1, wherein the discharging is performed using a nozzle plate having nozzles which is disposed in a reservoir for the toner composition liquid and one vibration generating unit having a vibrating surface disposed in parallel with the nozzle plate so as to utilize resonance phenomenon of the toner composition liquid present in the reservoir.

9. The method according to claim 8, wherein the resonant frequency of the liquid present in the reservoir is lower than the resonant frequency of a structure having a member constituting the reservoir and the nozzle plate.

10. The method according to claim 1, wherein the nozzles each have a pore size of 1 μm to 40 μm.

11. The method according to claim 1, wherein the solvent is an organic solvent, and the solidifying is removing the organic solvent from the liquid droplets.

12. The method according to claim 1, wherein a ratio A/B satisfies the relation 0.1≦A/B≦4.0, where A denotes an amount of the acid-modified hydrocarbon wax added to the toner composition and B denotes an amount of the unmodified hydrocarbon wax added to the toner composition.

13. The method according to claim 1, wherein a sum A+B is 0.1 parts by mass to 20 parts by mass per 100 parts by mass of the binder resin, where A denotes an amount of the acid-modified hydrocarbon wax added to the toner composition and B denotes an amount of the unmodified hydrocarbon wax added to the toner composition.

14. The method according to claim 1, wherein the acid-modified hydrocarbon wax has an acid value of 1 mgKOH/g to 90 mgKOH/g.

15. The method according to claim 1, wherein the acid-modified hydrocarbon wax and the unmodified hydrocarbon wax each have a melt viscosity of 1 mPa·s to 30 mPa·s at 120° C.

16. The method according to claim 1, wherein the acid-modified hydrocarbon wax is produced by modifying a paraffin wax with maleic anhydride.

17. The method according to claim 1, wherein the unmodified hydrocarbon wax is a paraffin wax.

18. A toner obtained by the method comprising:
discharging a toner composition liquid from a plurality of nozzles to form liquid droplets thereof, the toner composition liquid being prepared by dissolving or dispersing in a solvent a toner composition containing at least a binder resin, a colorant, an acid-modified hydrocarbon wax and an unmodified hydrocarbon wax, the waxes serving as a releasing agent, and
solidifying the liquid droplets so as to form solid particles,
wherein the toner has a particle size distribution (mass average particle diameter/number average particle diameter) of 1.00 to 1.15.

19. The toner according to claim 18, having a mass average particle diameter of 1 μm to 20 μm.
